(19) United States
(12) Patent Application Publication
(10) Pub. No.: US 2026/0330396 A1
(43) Pub. Date: Oct. 22, 2026

(54) METHODS AND SYSTEMS FOR DELIVERY MODE OPTIMIZATION INCLUDING COORDINATION OF THIRD PARTY ITEM SHIPMENTS

(71) Applicant: Target Brands, Inc., Minneapolis, MN (US)

(72) Inventors: Matthew Michael Schlicksup, St. Anthony, MN (US); Sara Sipple, New Brighton, MN (US); Matthew James Milosevich, St. Anthony, MN (US)

(21) Appl. No.: 19/181,219

(22) Filed: Apr. 16, 2025

(51) Int. Cl. G06Q 10/0834; G06Q 10/0833

(52) U.S. Cl. CPC G06Q 10/0834; G06Q 10/0833

(57) ABSTRACT

Systems and methods for optimizing delivery modes for transporting items between nodes of a supply chain are disclosed herein. In some aspects, the delivery modes are optimized to ultimately deliver items ordered by a customer to the customer’s location or other designated destination for the ordered items. Optimal delivery modes are selected that provide for transportation of items to a destination, for both items fulfilled from third party nodes and from enterprise nodes, while balancing meeting delivery within a promised timeframe and delivery at the lowest available price point. Additionally, the disclosed systems allow third party partners to utilize the enterprise’s contracted shipping rates for carriers, while also increasing the efficiency with which the enterprise can receive and track item shipment data (and provide shipping updates to customers).

### BACKGROUND

An enterprise that offers items for sale to be delivered to customers at a destination may be transported from an origin node to the destination through a line hauling system, which routes items from nodes to the destination, and in some examples, through intermediate sortation locations. The items may be transported along routes between locations via one or more carriers (for example, long haul carriers or last mile delivery (LMD) carriers). Enterprises employ historical methods to evaluate efficient carrier selections to transport items from a selected node to the destination. However, some enterprises expand their sale offerings by acting as an online marketplace for third party partner items. Historically, the enterprise node and/or selection systems do not have the capability to effectively select nodes and/or carriers when orders taken from a shared online marketplace may originate from either an enterprise node or a third party node.

### SUMMARY

The disclosure herein generally relates to systems and methods for optimizing delivery modes for transporting items between nodes of a supply chain. In some aspects, the delivery modes are optimized to ultimately deliver items ordered by a customer to the customer’s location or other designated destination for the ordered items. In some examples, to account for potential changes that may have occurred in the time between order placement and shipping of the item(s), the delivery mode selections may be updated at the time the order is prepared for shipment. Optimal delivery modes are selected that provide for transportation of items to a destination, for both items sourced/fulfilled from third party nodes and from enterprise nodes, while balancing meeting delivery within a promised timeframe and delivery at the lowest available price point. Additionally, the disclosed systems allow third party partners to utilize the enterprise’s contracted shipping rates for carriers, while also increasing the efficiency with which the enterprise can receive and track item shipment data (and provide shipping updates to customers).

Accordingly, the present application describes a computing system, comprising: at least one processor; and at least one memory storing computer-executable instructions, the computer-executable instructions when executed by the at least one processor causing the computing system to: receive and storing carrier information in a carrier data store, the carrier information comprising carrier rates, carrier services, carrier zones, and carrier time, for each of a plurality of enterprise nodes and for each of a plurality of third party nodes; receive, at a customer user interface associated with an enterprise, an order from a customer for one or more items to be delivered to a customer address, wherein the order may be fulfilled from an enterprise node of the plurality enterprise nodes or a third party node of the plurality of third party nodes; process, at an order coordination application, the order; receive, at a delivery mode optimizer application, from the order coordination application, a quote request associated with the order; determine, at the delivery mode optimizer application, whether the order is to be fulfilled from an enterprise node or a third party node; based on whether the order is to be fulfilled from an enterprise node of the plurality of enterprise nodes or a third party node of the plurality of third party nodes, evaluate, at the delivery mode optimizer application, carrier options for the order at the delivery mode optimizer, wherein: when the order is to be fulfilled from an enterprise node of the plurality of enterprise nodes, evaluating carrier options for the order comprises: receiving carrier information associated with the plurality of enterprise nodes from the carrier data store; and applying one or more rules to the carrier information associated with the plurality of enterprise nodes, wherein the one or more rules include at least time and cost considerations, and when the order is to be fulfilled from a third party node of the plurality of third party nodes, evaluating carrier options for the order comprises: receiving carrier information associated with the plurality of third party nodes from the carrier data store; and applying one or more rules to the carrier information associated with the plurality of third party nodes, wherein the one or more rules include at least time and cost considerations; and assign, at the delivery mode optimizer application, based on the evaluated carrier options, one or more optimal shipping modes to the order, the optimal shipping modes specifying a carrier and an assigned node, wherein: when the order is to be fulfilled from an enterprise node, at least one optimal shipping mode is assigned to the order, and the assigned node is one of the plurality of enterprise nodes, and when the order is to be fulfilled from a third party node, a plurality of optimal shipping modes are assigned to the order, and the assigned node is one of the plurality of third party nodes.

In examples, the described computing system further comprises instructions to: receive, at an order allocator platform, a selected shipping carrier associated with a selected optimal shipping mode of the one or more optimal shipping modes; allocate, at the order allocator platform, the order to one or more nodes consistent with the selected optimal shipping mode, based at least on item availability at the nodes, success rates of the nodes, and shipping schedules for the nodes; receive, at the delivery mode optimizer application, a confirmation from the assigned node of the selected optimal shipping node, a confirmation including a request to reevaluate the carrier options for the selected optimal shipping mode; reevaluate the carrier options for the selected optimal shipping mode, based on the time that the order is prepared at the assigned node; based on the reevaluated carrier options, assign a final optimal shipping mode to the order, the final optimal shipping mode specifying a final carrier and the assigned node; communicate the final optimal shipping mode to a shipping label and manifest application; generate, at the shipping label and manifest application, a label associated with the order; and provide the label to the assigned node.

In examples, the described computing system further comprises instructions to: receive, at a shipping label and manifest application, a selected shipping carrier associated with a selected shipping mode; and based on whether the order is to be fulfilled from an enterprise node of the plurality of enterprise nodes or a third party node of the plurality of third party nodes, generate, at the shipping label and manifest application, a label associated with the order, wherein: when the order is to be fulfilled from an enterprise node of the plurality of enterprise nodes, the generated label comprises enterprise-sensitive data, and when the order is to be fulfilled from a third party node of the plurality of third party nodes, generating the label comprises encoding, at the label creation application, the label with information identifying the order as being associated with the enterprise, wherein the generated label does not comprise enterprise-sensitive data.

In examples, the described computing system further comprises instructions to: receive the generated label; provide the generated label to an enterprise fulfillment computing system; receive, from the enterprise fulfillment computing system, shipment data associated with shipping of the item from the enterprise node to the customer address via the selected shipping carrier; and receive, directly from the selected shipping carrier, realtime shipping updates related to the generated label.

In examples, the described computing system further comprises instructions to: receive the generated label; provide the generated label to a third party computing system; receive, from the third party computing system, shipment data associated with shipping of the order from the third party node to a the customer address via the selected shipping carrier; and receive, directly from the selected shipping carrier, realtime shipping updates related to the generated label.

The present application further describes a method comprising: receiving and storing carrier information in a carrier data store, the carrier information comprising carrier rates, carrier services, carrier zones, and carrier time, for each of a plurality of enterprise nodes and for each of a plurality of third party nodes; receiving, at a customer user interface associated with an enterprise, an order from a customer for one or more items to be delivered to a customer address, wherein the order may be fulfilled from an enterprise node of the plurality enterprise nodes or a third party node of the plurality of third party nodes; processing, at an order coordination application, the order; receiving, at a delivery mode optimizer application, from the order coordination application, a quote request associated with the order; determining, at the delivery mode optimizer application, whether the order is to be fulfilled from an enterprise node or a third party node; based on whether the order is to be fulfilled from an enterprise node of the plurality of enterprise nodes or a third party node of the plurality of third party nodes, evaluating, at the delivery mode optimizer application, carrier options for the order at the delivery mode optimizer, wherein: when the order is to be fulfilled from an enterprise node of the plurality of enterprise nodes, evaluating carrier options for the order comprises: receiving carrier information associated with the plurality of enterprise nodes from the carrier data store; and applying one or more rules to the carrier information associated with the plurality of enterprise nodes, wherein the one or more rules include at least time and cost considerations, and when the order is to be fulfilled from a third party node of the plurality of third party nodes, evaluating carrier options for the order comprises: receiving carrier information associated with the plurality of third party nodes from the carrier data store; and applying one or more rules to the carrier information associated with the plurality of third party nodes, wherein the one or more rules include at least time and cost considerations; and assigning, at the delivery mode optimizer application, based on the evaluated carrier options, one or more optimal shipping modes to the order, the optimal shipping modes specifying a carrier and an assigned node, wherein: when the order is to be fulfilled from an enterprise node, at least one optimal shipping mode is assigned to the order, and the assigned node is one of the plurality of enterprise nodes, and when the order is to be fulfilled from a third party node, a plurality of optimal shipping modes are assigned to the order, and the assigned node is one of the plurality of third party nodes.

In examples, the described method further comprises: receiving, at an order allocator platform, a selected shipping carrier associated with a selected optimal shipping mode of the one or more optimal shipping modes; allocating, at the order allocator platform, the order to one or more nodes consistent with the selected optimal shipping mode, based at least on item availability at the nodes, success rates of the nodes, and shipping schedules for the nodes; receiving, at the delivery mode optimizer application, a confirmation from the assigned node of the selected optimal shipping node, a confirmation including a request to reevaluate the carrier options for the selected optimal shipping mode; reevaluating the carrier options for the selected optimal shipping mode, based on the time that the order is prepared at the assigned node; based on the reevaluated carrier options, assigning a final optimal shipping mode to the order, the final optimal shipping mode specifying a final carrier and the assigned node; communicating the final optimal shipping mode to a shipping label and manifest application; generating, at the shipping label and manifest application, a label associated with the order; and providing the label to the assigned node.

In examples, the described method further comprises: receiving, at a shipping label and manifest application, a selected shipping carrier associated with a selected shipping mode; and based on whether the order is to be fulfilled from an enterprise node of the plurality of enterprise nodes or a third party node of the plurality of third party nodes, generating, at the shipping label and manifest application, a label associated with the order, wherein: when the order is to be fulfilled from an enterprise node of the plurality of enterprise nodes, the generated label comprises enterprise-sensitive data, and when the order is to be fulfilled from a third party node of the plurality of third party nodes, generating the label comprises encoding, at the label creation application, the label with information identifying the order as being associated with the enterprise, wherein the generated label does not comprise enterprise-sensitive data.

In examples, the described method further comprises: receiving the generated label; providing the generated label to an enterprise fulfillment computing system; receiving, from the enterprise fulfillment computing system, shipment data associated with shipping of the item from the enterprise node to the customer address via the selected shipping carrier; and receiving, directly from the selected shipping carrier, realtime shipping updates related to the generated label.

In examples, the described method further comprises: receiving the generated label; providing the generated label to a third party computing system; receiving, from the third party computing system, shipment data associated with shipping of the order from the third party node to the customer address via the selected shipping carrier; and receiving, directly from the selected shipping carrier, realtime shipping updates related to the generated label.

The present application further describes a computing system comprising: at least one processor; and at least one memory storing computer-executable instructions, the computer-executable instructions when executed by the at least one processor causing the computing system to: receive and storing carrier information in a carrier data store, the carrier information comprising carrier rates, carrier services, carrier zones, and carrier time, for each of a plurality of enterprise nodes and for each of a plurality of third party nodes; receive, at a customer user interface associated with an enterprise, an order from a customer for one or more items to be delivered to a customer address, wherein the order may be fulfilled from an enterprise node of the plurality enterprise nodes or a third party node of the plurality of third party nodes; process, at an order coordination application, the order; receive, at a delivery mode optimizer application, from the order coordination application, a quote request associated with the order; determine, at the delivery mode optimizer application, that the order is to be fulfilled from a third party node; evaluate, at the delivery mode optimizer application, carrier options for the order at the delivery mode optimizer, wherein evaluating carrier options for the order comprises: receiving carrier information associated with the plurality of third party nodes from the carrier data store; and applying one or more rules to the carrier information associated with the plurality of third party nodes, wherein the one or more rules include at least time and cost considerations; assign, at the delivery mode optimizer application, based on the evaluated carrier options, one or more optimal shipping modes to the order, the optimal shipping modes specifying a carrier and an assigned node, wherein a plurality of optimal shipping modes are assigned to the order, and the assigned node is one of the plurality of third party nodes; provide the plurality of optimal shipping modes to a third party computing system; receive a responsive communication from the third party computing system comprising a signal of a selected shipping mode of the plurality of optimal shipping modes; provide the selected shipping mode to a shipping label and manifest application, including a selected carrier associated with a selected shipping mode; and generate, at the shipping label and manifest application, a label associated with the order, wherein generating the label comprises encoding, at the label creation application, the label with information identifying the order as being associated with the enterprise, wherein the generated label does not comprise enterprise-sensitive data.

In examples, the described computing system further comprises instructions to: receive the generated label; provide the generated label to the third party computing system; receiving, from the third party computing system, shipment data associated with shipping of the order from the third party node to the customer address via the selected carrier; and receiving, directly from the selected carrier, realtime shipping updates related to the generated label.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example system wherein orders are placed for an item offered for sale at an enterprise system, and a carrier is selected to transport the item from an enterprise node or a third party partner node to a destination, according to an example.

FIG. 2A illustrates an example system for receiving item orders, selecting carriers, and generating shipping labels for items including items fulfilled from third party partner nodes, according to an example.

FIG. 2B illustrates an example enterprise fulfillment operations system, according to an example.

FIG. 3 illustrates an example schematic for receiving item orders, selecting carriers, and generating shipping labels for items including items fulfilled from third party partner nodes, according to an example.

FIG. 4 illustrates an example process for receiving item orders, selecting carriers, and generating shipping labels for items including items fulfilled from third party partner nodes, according to an example.

FIG. 5 illustrates example operations for selecting one or more optimal shipping modes for one or more items of an order, according to an example.

FIG. 6 illustrates an example third party user interface for selection of a shipping carrier/mode from a set of provided optimal shipping options, according to an example.

FIG. 7 illustrates an example block diagram of a computing system.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Historically, an enterprise that offers items for sale to be delivered to customers at a destination may be transported from an origin node to the destination through a line hauling system, which routes items from nodes to the destination, and in some examples, through intermediate sortation locations. Enterprises may employ historical methods to evaluate efficient carrier selections to transport items from a selected node (or origin) to the destination. Efficient supply chain management requires leveraging the fastest, most efficient and cost-effective methods of shipping goods to a destination. Many factors such as cost, speed, delivery schedules, and service options may be taken into account to determine the best shipping option. In some examples, some considerations may be more important than others, depending on particular circumstances. For example, in instances where a delivery must take place within a given timeframe, cost considerations may give way to speed considerations. The enterprise may have contracts with a plurality of carrier services that outline prices/rates, capacities, routes, and/or other features. These contracts may include rates and other business terms that are beneficial to the enterprise and/or the carrier.

Existing methods of selecting shipping modes may analyze shipping factors and make a determination of which carrier and service option will be used for a delivery at the time an order is placed for goods. However, delivery schedules can change due to factors such as delays or orders being prepared faster than expected; therefore, the optimal delivery mode may change between the time an order is placed and when the order is ready to be shipped. Additionally, some enterprises expand their sale offerings by acting as an online marketplace for third party partner items. Historical enterprise node and/or selection systems do not have the capability to effectively select nodes and/or carriers that account for changes between order placement and shipping, especially when orders taken from a shared online marketplace may originate from either an enterprise node or a third party node.

Further, historically, when an enterprise such as a retail enterprise offers items for sale by acting as an online marketplace for third party partner items, carriers would typically arrange with the third party partner for purposes of shipment, particularly in instances where the third party partner selects the carrier to be used. As such, the computer systems of the carriers selected by the third party partner provide status and tracking updates directly to the third party partner vendor. In order for the enterprise to provide shipping updates to customers and to track or gather any shipping data for internal uses, the enterprise computer systems would typically send requests to the third party partner vendor computing systems and then wait for a response including the requested status/tracking data; or must wait for such data in the absence of the request. This technological configuration results in the need for status/update messages to be sent (by the enterprise computing systems) to the third party partner computing systems, and/or the need for the enterprise computing systems to wait for the update/status data. Therefore, this technological arrangement means that the enterprise system does not receive realtime status or tracking update data from the carriers of items provided by the third party partner, and cannot internally utilize that data or provide that data to customers on a timely or realtime basis. Specifically, this historical technological arrangement results in a reliance on the third party vendor computing system, which may be technologically unsophisticated and/or incapable of handling the type and/or volume of data being received from carrier systems that needs to be routed to the enterprise systems; this may cause delay in receiving data, a lack of data received at all, and/or inaccurate/insufficient data being received.

Disclosed herein are systems and methods for optimizing delivery modes for transporting items between nodes of a supply chain. In some aspects, the delivery modes are optimized to ultimately deliver items ordered by a customer to the customer’s location or other designated destination for the ordered items. In some examples, to account for potential changes that may have occurred in the time between order placement and shipping of the item(s), the delivery mode selections may be updated at the time the order is prepared for shipment. Optimal delivery modes are selected that provide for transportation of items to a destination, for both items sourced/fulfilled from third party nodes and from enterprise nodes, while balancing meeting delivery within a promised timeframe and delivery at the lowest available price point. Additionally, the disclosed systems allow third party partners to utilize the enterprise’s contracted shipping rates for carriers, while also increasing the efficiency with which the enterprise can receive and track item shipment data (and provide shipping updates to customers).

Once the optimal delivery mode is selected, for items fulfilled from enterprise nodes, the optimal delivery mode is transmitted to enterprise fulfillment operations to initiate shipping processes (e.g. mobilization of shipping vehicles, printing of shipping labels for affixing to the picked and packed package containing the item orders etc.) For items fulfilled from enterprise, nodes, a plurality of optimal delivery modes are provided to the third party partner vendor (along with necessary quotes) based at least in part on realtime data. Then, based on a selection of a shipping mode by the third party partner vendor, the disclosed system generates and encodes a shipping label for the item(s), such that the encoding of the shipping label causes the system to be able to directly receive realtime shipping status/tracking update data for the item(s) from the selected carriers.

The disclosed technological features provide the enterprise systems the ability to efficiently determine optimal shipping options for items regardless of whether they originate from enterprise or third party nodes; to take real-time changes into account during such determinations; to output different types or formats of optimal shipping modes based on fulfillment source type; to receive realtime shipping status/tracking update data even for third party items directly from carriers; to eliminate reliance on slow or incapable third party partner vendor computing systems; and to reduce or eliminate the number of shipping update data request transmissions from the enterprise system to the third party computing systems.

In some examples, shipping mode options may be determined at an enterprise carrier selection application, also referred to herein as a delivery mode optimization (DMO) application. The DMO application allocates orders to available nodes and potential carriers based on various factors such as costs, node data, previous node allocation decisions, and real-time carrier options. An example of a DMO system is described in U.S. Patent No. 11,823,117, entitled, “Delivery mode optimization in supply chain architecture,” which is incorporated herein in its entirety by reference, except for any inconsistencies. A further example of such a system is described in U.S. Patent Application No. 19/074,175, entitled “METHODS AND SYSTEMS FOR COORDINATION OF THIRD PARTY ITEM SHIPMENTS”, and filed Mar. 7, 2025. In some examples, the DMO application may generate a list of potential carriers for a shipment of items from a third party node. In some examples, the DMO application may select a single “best” option node and carrier for a shipment of items from an enterprise node. The analysis and selection performed at the DMO application may include a cost calculator to determine the overall shipping cost for an order based on different carriers from different nodes and a time calculator to calculate the overall time a shipment is expected to take to reach a customer from various nodes. A carrier evaluation module then evaluates the possible carrier options, taking into account the results from the time and cost calculators. The DMO application determines which carrier, service type, and – in some examples, – node will provide the best combination/balance of low cost and timeliness to complete the order within a designated time frame to suit particular factors. Once a shipping mode option is identified (either at the DMO application or as selected by a third party, the carrier assignment/shipping mode may be reassessed to capture any changes that have occurred during the evaluation time.

When an order is received by the enterprise, order information (for example, including item information and node information (e.g. enterprise node or third party node)), may be provided to the DMO application as part of a quote or rate request. Based on the request type (e.g., based on whether the items of the order are to be fulfilled/sourced from an enterprise node or a third party node), the DMO application may generate differently formatted responses: node selection/confirmation and single carrier selection in enterprise node-fulfilled items, or a defined/confirmed node and a list of multiple potential carriers for third party-fulfilled items.

In some examples, even when items of an order are to be fulfilled from a third party node, the enterprise (instead of the third party partner) may select the service level for the shipment of the item. In such examples, the third party partner may initially pick and pack an item, and then send the order and package detail to the enterprise. The enterprise may then utilize the DMO application to determine the best available carrier for the third-party retailer.

In some examples, the third party chooses the service level. In such examples, the third-party carrier provides the order and package information to the enterprise, and the DMO application may generate a list of selected or feasible carriers that can fulfill the order from the third-party node. This generated information may include the calculated overall cost and time for delivery for each selected or feasible carrier. The DMO application may not determine a single particular node/carrier that is the best to fulfill an order in the cheapest and most timely manner for the third-party retailer. Instead, it may return a list/set of carrier options, delivery timings, and costs to the third party partner, which can then choose which of the presented carrier options to use to fulfill the order. In such examples, the computing system reserves capacity within the enterprise’s contracted carrier quotas, at all such carrier service levels that correspond to the presented carrier options. The third party partner may then select one of the presented carriers, and the reserved capacity relating to the non-selected service levels will be released. Alternatively, the third-party can choose to use none of the presented carrier options and instead to negotiate shipping costs with their own independent carriers (and the reserved capacity associated with all presented carriers will be released).

Regardless of whether Target or the third-party retailer selects the carrier service level, once a final carrier is selected, that selection information is provided to the SLAM application, which then creates a shipping label based on the final selected carrier option, and provides the shipping label to the enterprise fulfillment systems and/or order coordination systems. An example of a SLAM system is also described in U.S. 11,823,117, which is incorporated herein in its entirety as noted above. The shipping label is then routed to the enterprise node or third party partner, and/or third party node) as appropriate. The SLAM application may generate a different shipping label type based on the type of order (e.g. fulfilled from an enterprise node or third party node). For example, when a shipment of items of the order is to be fulfilled/sourced from a third party node, SLAM may create a shipping label that differs from a standard (e.g. enterprise node) shipping label, in that some internal routing identifiers are omitted from the shipping label (which is to be sent to a third party system and/or third party node). Additionally, in some examples, when a shipment of items of the order is to be fulfilled/sourced from a third party node, SLAM may create a shipping label that is encoded as though the order package originated from an enterprise node (e.g. such that the enterprise still receives shipping updates directly from the selected carrier after the item order has shipped, instead of needing to receive them second-hand from a third party system). This allows the enterprise computing systems to more efficiently provide shipment status to other internal enterprise systems, as well as to the customer user interfaces. After creation, the shipping label created and distributed to the appropriate systems, a physical shipping label corresponding to the generated label is printed at the selected node, so that the physical label may be affixed to the package. A shipping invoice may then be created and sent to the selected carrier for payment.

The disclosed systems and methods result in various improvements to the enterprise computing systems and related technological environment. First, the analysis performed by the DMO application takes into account the most updated carrier and node-specific information, allowing for optimal shipping mode selection that is based on both cost and delivery time. The DMO application’s analysis may be performed differently, depending on determinations of whether the fulfillment node for the order is an enterprise node or a third party node. When the fulfillment node is an enterprise node, the DMO application may select a single optimal shipping mode for internal routing and carrier selection; this promotes efficient calculation by the DMO application and related enterprise fulfillment systems. When the fulfillment node is a third party node, the DMO application may identify a plurality of optimal shipping modes for presentation to a third party for selection/approval. This promotes system efficiencies, as the third party computing system receives the best several options, and the enterprise computing system/DMO application does not need to do multiple re-selections of optimal shipping modes (for example, if only one option at a time were presented to the third party and was subsequently rejected). Additionally, in some examples, the DMO application may perform a carrier reevaluation after an order is picked and packed at an assigned node (regardless of whether the node is an enterprise node or a third party node), to ensure that the carrier transporting the package is selected while taking into account any factors that may have changed during fulfillment operations. Further, the generated shipping label is prepared differently based on whether the order is to be fulfilled from an enterprise node or a third party node. When the order is fulfilled from a third party node, the label may be encoded such that carriers can provide real time shipping status updates directly to the enterprise computing systems, regardless of whether the order originated from an enterprise node or an third party node. This eliminates reliance on slow or unreliable third party computing systems to relay shipping updates. When the order is fulfilled from a third party node, the label may also differ from one destined for an enterprise node, in that any enterprise-sensitive routing information is removed from/not included on the label. This ensures that the enterprise’s secure information remains safe, even when labels are generated that will be transmitted to third party computing systems.

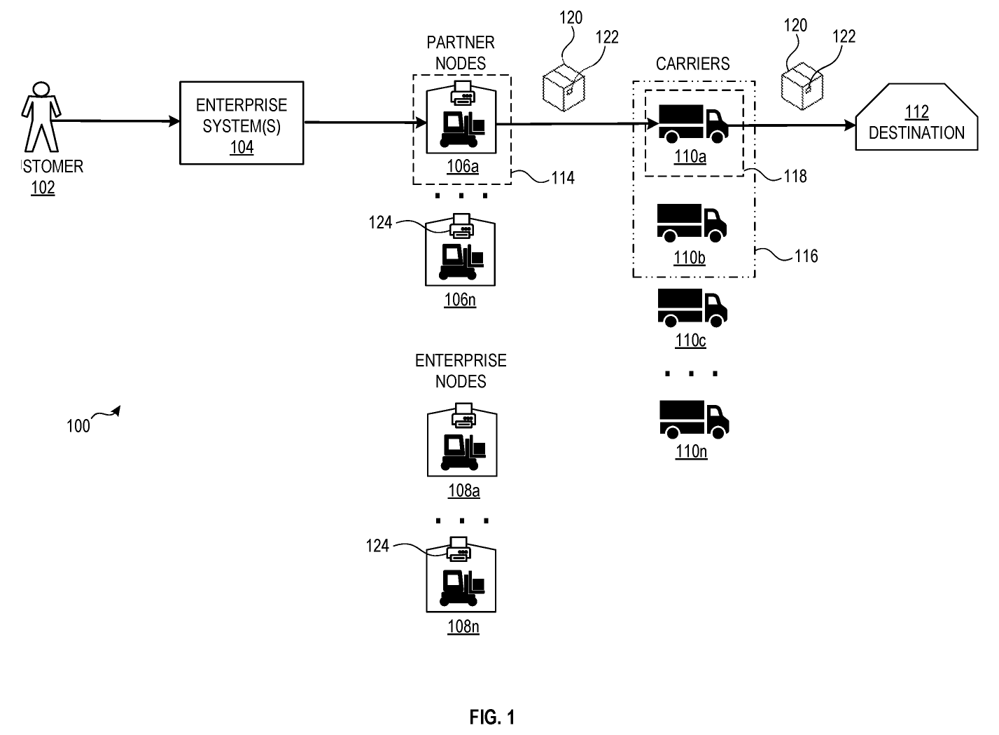

These and other examples will be explained in more detail below with respect to FIGS. 1-7.

FIG. 1 illustrates an example system 100 wherein orders are placed for an item offered for sale at an enterprise system, and a carrier is selected to transport the item from an enterprise node or a third party partner node to a destination. In some examples, a customer 102 places an order for one or more items via one or more enterprise systems 104. In an example, the enterprise may offer for sale, on an online retail site, items associated with the enterprise as well as items associated with a third party partner vendor. In some examples, the online retail site may include separate webpages (for example, separate marketplaces) where the customer 102 may view and select the enterprise items and the third party partner vendor items. In other examples, the online retail site may include the third party partner vendor items on a same webpage as the enterprise items, where the customer 102 may view and select either one or both. In examples, instead of an online retail site, the items may be similarly shown for viewing and selection on an application (for example, a mobile application).

In examples, the placed order for the one or more items is routed to one or more supply nodes that will supply (and/or otherwise coordinate the shipping of) the ordered items. In examples, nodes may include warehouses, stores, manufacturing facilities, distribution centers, consolidation centers, and other appropriate node types. In examples, a plurality of partner nodes 106a-106n are supported in the enterprise ordering system. Each of the partner nodes 106a-106n is associated with the third party partner vendor, and have the ability to supply a third party partner vendor item (e.g. serve as an item origin). In examples, a plurality of enterprise nodes 108a-108n are associated with the third party partner vendor, and have the ability to supply an enterprise item (e.g. serve as an item origin or source). Each node 106a-106n, 108a-108n may include a printer 124 configured to receive generated shipping labels from partner and/or enterprise systems, and configured to print associated physical labels for affixing to item packages to be shipped.

One or more of the enterprise systems 104 may assign/allocate each item of the customer’s 102 order to an appropriate node for fulfillment, which may include picking and packing the item for shipping. In an example, a plurality of carriers 110a-110n are available for shipment of the item from its one or more of the enterprise systems 104 may select an appropriate carrier for shipment of the item from a source node to the destination 112 (for example, a destination such as a home, business, or other location provided by the customer). Although carriers 110a-110n are depicted in the particular schematics of the Figures as a truck, a carrier may include one or more modes of transporting the item, including trucks, semi trucks, busses, vans, passenger vehicles, trains/rail transportation modes, freighters/barges/waterway transportation modes, air transportation modes, and/or other modes of transportation. In some examples, carriers 110a-110n may include private carriers, public carriers, and/or last-mile delivery carriers. In examples, the enterprise has one or more contracts with each carrier 110a-110n that define at least certain rates and/or available services. In examples, these contracts may provide advantages such as contracted rates and/or shipping times that are available to the enterprise. The enterprise systems may, in some examples, determine a subset of eligible carriers 116 from which a selected carrier 118 is ultimately determined by the enterprise (or enterprise users) or the third party partner vendor. The enterprise systems may, in some examples, determine a proposed selected carrier 118 that may be selected (or, in some examples, rejected) by the third party partner vendor. In some examples, the third party partner vendor selects a selected carrier 118.

The shipped item 120 is placed into one or more packages, each of which includes a shipping label 122 affixed thereto, which may include information such as origin node 114, destination 112, carrier 118, intermediate nodes (for example, sortation centers, distribution centers, etc.), and other information relevant for shipping and tracking of the shipped item package.

In a particular example shown, an item associated with the third party partner vendor may be allocated to (e.g. may originate from) a partner node 106a as the selected/allocated origin node 114. In the particular example, from an eligible group of carriers 116, a carrier 118 may be selected to transport the item from the origin node 114 to the destination 112. The item package 120 is provided to the selected carrier 118 at the selected node 114 for delivery to the destination 112.

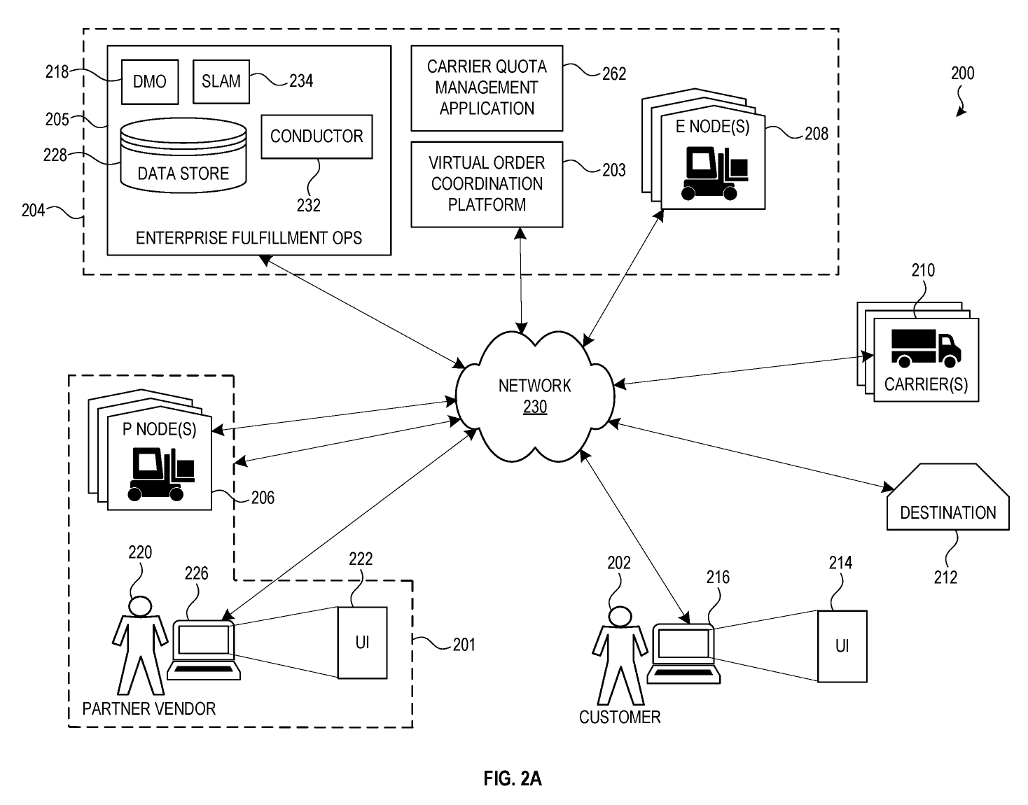

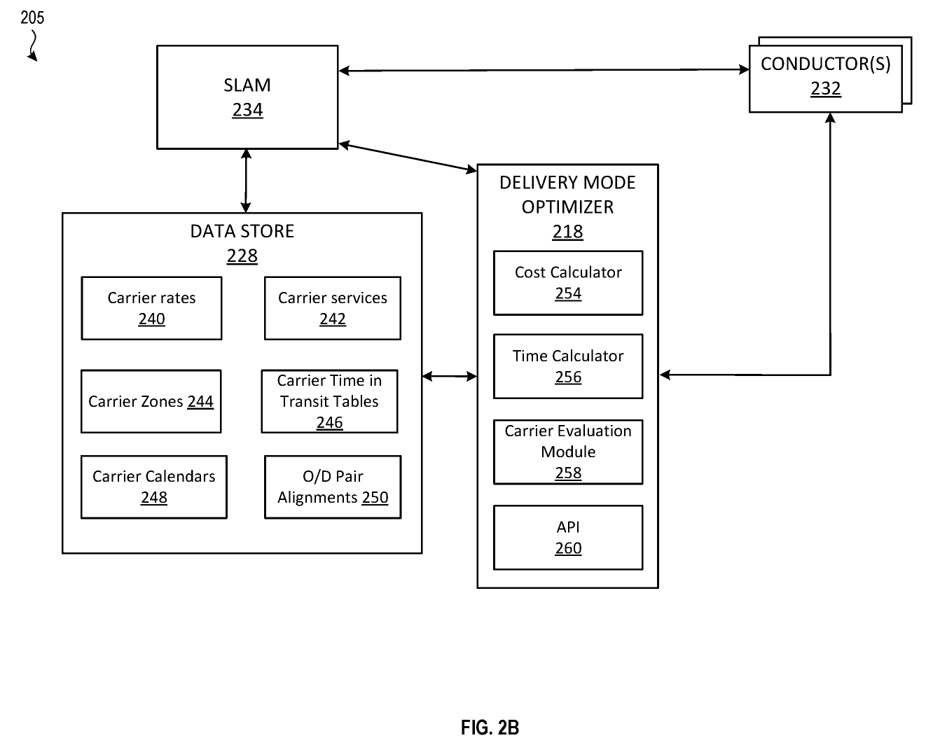

FIG. 2A illustrates an example system 200 for receiving item orders, selecting carriers, and generating shipping labels for items, including items fulfilled from third party partner nodes. In some examples, the devices, applications, and systems of system 200 are configured to send and receive data via network 230. In some examples, as described herein, network 230 may include a computer network, an enterprise intranet, the Internet, a LAN, a Wide Area Network (WAN), wireless transmission mediums, wired transmission mediums, other networks, and combinations thereof. Although network 230 is shown as a single network in FIG. 2, this is shown as an example and the various communications described herein may occur over the same network or a number of different networks.

In some examples, enterprise systems and operations 204 may include enterprise fulfillment operations (also referred to as an enterprise fulfillment application) 205, virtual order coordination application (also referred to as an order coordination application or platform) 203, and one or more enterprise nodes 208. In some examples, third party partner vendor (herein also referred to as a partner vendor, third party partner, partner, third party, and third party vendor) 201 systems and operations 201 may include a partner vendor user 220, associated partner vendor device 226, partner user interface 222 (which may be provided to the partner vendor device 226 via one or more applications of enterprise systems 204), and one or more partner vendor nodes 206. Each of enterprise nodes 208 and partner vendor nodes 206 may include at its location a label printer (for example, printer 124) configured to receive a shipping label as described herein, and to print the physical label to be affixed to the shipped item (for example, to the box, envelope, tube, crate, or other appropriate packaging for the item) for routing and tracking of the shipped item. The shipping label may be scanned by node systems 206, 208, carrier systems 210, and/or destination systems 212 to transmit data back to the enterprise systems 204 such as virtual order coordination application 203.

In some examples, a customer user 202 (for example, a customer 102) may place a virtual order at a user interface 214 (for example, an online shopping interface or application shopping interface including a virtual shopping cart) via a device 216. In an example, user interface 214 is a web application. In other examples, user interface 214 is a device application. User interface 214 may be presented to the customer user 202 via a display of device 216. In some examples, device 216 may be a desktop computer, a laptop computer, a tablet, a cell phone or smart phone, a smart TV, a smart wearable device, or other appropriate electronic device which is capable of displaying and facilitating interaction with the user interface 214.

When the customer user 202 is viewing an item or searching for an item, user interface 214 may display both enterprise items and third party partner vendor items. In some examples, the user interface 214 may include separate pages (for example, separate marketplaces) where the customer 202 may view and select either of the enterprise items or the third party partner vendor items. In other examples, the user interface 214 may include the third party partner vendor items on a same page (e.g. marketplace) as the enterprise items, where the customer 202 may view and select either one or both. When the customer user 202 purchases one or more items via user interface 214, a virtual order for the items is created within the enterprise systems. Methods and system for order allocation are further described in U.S. Patent No. 11,514,395, entitled, “System for cost efficient order fulfillment,” which is incorporated herein in its entirety by reference, except for any inconsistencies.

Order data and associated node allocation data may be received at the virtual order coordination application 203. Virtual order coordination application 203 may include a markup engine, configured to receive quotes calculated at one or more enterprise fulfillment operations 205 applications and to calculate and apply a markup to the quote. Virtual order coordination application 203 may also be configured to send data, such as requests for quotes and label creation, to one or more enterprise fulfillment operation 205. Virtual order coordination application 203 may be configured to receive the generated quotes and created labels from the one or more enterprise fulfillment operation 205, and to transmit associated data and requests to third party partner vendor systems 201. Virtual order coordination application 203 may further be configured to receive order fulfillment detail data from partner nodes 206 as well as enterprise nodes 208. Virtual order coordination application 203 may also be configured to receive shipment status and tracking data directly from carriers 210. Virtual order coordination application 203 is configured to link a virtual order with an associated generated, encoded shipping label so that received fulfillment, status, and tracking data associated with the shipping label can be then associated with the virtual order; this allows for enterprise systems and databases to be updated regarding virtual order updates, and for virtual order updates to also be provided to the customer user.

Enterprise fulfillment systems and operations 205 may include a DMO application 218, SLAM application 234, one or more databases/data stores 228, and other necessary applications and systems, including conductor systems 232. The conductor systems 232 may include services executing within the enterprise which manage requests sent to internal applications such as the DMO application 218 and SLAM application 234 when those requests are received from entities external to the enterprise, and also control output of data to external entities. Enterprise fulfillment systems and operations 205 are configured to receive requests for quote generation (and associated carrier selection) and shipping label creation (for example, at DMO application 218 and SLAM application 234, respectively). Enterprise fulfillment systems and operations 205 are configured to transmit the generated quotes (and associated carrier selections) and generated shipping labels to the virtual order coordination application 203.

Enterprise systems and operations 204 may also include a carrier quota management application 262. In some examples, the carrier quota management application 262 may be a part of (or may operate within enterprise fulfillment systems and operations 205). In some examples, where the enterprise has contracted carrier quotas with carriers (for examples, carriers with which the enterprise has contracted rates), the carrier quota management application 262 is configured to receive one or more carrier options generated by the DMO application. The carrier quote management application 262 then reserves capacity within the enterprise’s contracted carrier quotas for the one or more carrier options for the relevant order, at all such carrier service levels that correspond to the one or more carrier options. Once a final carrier is selected for the order (e.g. either by the enterprise or by a third party), the carrier quota management application 262 receives indication of the selection, and the reserved capacity relating to any non-selected service levels and/or carrier options will be released (e.g. so that that capacity is available for other orders) by the carrier quota management application 262. If none of the one or more carrier options are selected for final shipment, the reserved capacity associated with any of the one or more carrier options will be released by the carrier quota management application 262.

Databases described herein, such as enterprise database (also referred to herein as enterprise data store) 228, may be of any appropriate database type, including distributed, centralized, relational/SQL, object-oriented, column-oriented, NoSQL, cloud-based, on-premises, operational, analytical, flat-file, network, graphical, time series, multi-model, and/or other database types. Although the databases described/shown herein are described as standalone databases for the purpose of illustrating the particular examples described, in some examples, the databases may be wholly or partially combined with other databases (including databases described relating to these examples and other enterprise databases) and may include other databases therein. Databases(s) 228 may receive and/or update stored data on a realtime basis, a periodic basis, and/or both realtime and periodic bases depending on the data type. Database(s) 228 may include carrier contract information such as contracted rates, services/service levels, zone information, timing/transit and schedule information and calendars, carrier capacity, carrier availability, and other carrier information. Database(s) 228 or other enterprise databases may include item data, which may, in some examples, include data relating to items sold/provided by the enterprise and the third party partner vendor, including product identification information/a product identifier, size, features, categories, pricing, vendor/supplier, storage and/or shipping considerations, inventory information related to partner nodes and/or enterprise nodes, and/or other information. Database(s) 228 or other enterprise databases may include location data, which may, in some examples, include data relating to destinations and various locations/nodes of the enterprise and partner, including physical locations (e.g. address, zip code, and/or coordinates), associated carriers, node type, staffing, inventory capacity and capability, origin/destination information (e.g. O/D pair alignments and data) and other information. Database(s) 228 or other enterprise databases may include virtual orders, customer user profiles, received fulfillment data, shipment status data, shipment tracking data, generated quotes, markup data, marked-up quotes, generated shipping labels, linked shipping label-virtual order pairs, and other data.

Third party partner vendor systems 201 may be configured to receive data associated with a virtual order for one or more third party vendor items placed with the enterprise user interface 214, for example, from virtual order coordination application 203. The third party partner vendor systems 201 are configured to request a quote for shipping of the item(s) of the virtual order, for example, utilizing carriers with which the enterprise has contracts (including contracted rates). Third party partner vendor systems 201 are configured to receive generated quotes (including marked-up quotes), assigned nodes, and selected carriers, and to evaluate them for selection or non-selection. In examples, selected carriers and associated quotes may be received at a partner user interface 222. By viewing and interacting with partner user interface 222 via a display of a partner user device 226, a partner vendor user 220 may select/choose an enterprise-selected carrier 210 and initiate indication of that selection to the enterprise systems 204, or may indicate selection of an independent/alternative carrier 210 to the enterprise system 204 (including, in some examples, providing information related to the selected alternative carrier to the enterprise system 204). In some examples, vendor user device 226 may be a desktop computer, a laptop computer, a tablet, a cell phone or smart phone, a smart TV, a smart wearable device, or other appropriate electronic device which is capable of displaying and facilitating interaction with the user interface 222.

Third party partner vendor systems 201 are configured to request a shipping label from the enterprise systems 204, and to receive the generated shipping label. The generated shipping label may be received at a printer at a partner node 206 for printing of a physical label. Third party partner vendor systems 201 are further configured to transmit fulfillment data to the virtual order coordination application 203, including fulfillment and pick-up by a carrier 210 selected by the enterprise or by the third party partner vendor.

Carriers 210 include systems configured to receive item package shipment requests from the enterprise systems 204 and/or partner vendor systems 201. The carriers 210 include, in some examples, scanner and/or machine-readable code reader systems (e.g., bar code, QR code, or the like), which are configured to scan or otherwise read the encoded shipping labels affixed to shipped item packages, and provide realtime package/item status and/or tracking update data to the enterprise systems 204 (for example, virtual order coordination application), even when the item package was fulfilled at a partner node 206.

Because the realtime scanned/read data is based on the encoded label, and because the virtual order coordination application 203 is configured to link the virtual order with any associated generated, encoded shipping label, the received realtime data is associated with the virtual order. The virtual order coordination application 203 and/or other enterprise systems 204 are then able to update data associated with the virtual order. This updated data may be used for analytics and operations internal to the enterprise, and/or may be provided to the customer user. The virtual order coordination application 203 and/or other enterprise systems 204 do not need to send/transmit data requests to carrier systems (or to the third party partner systems 201) to obtain accurate, realtime shipping status and/or tracking updates.

In a particular example, a customer user 202 may place an order for two items via user interface 214. The user interface 214 may be provided, for example, by the enterprise, for example as a retail website presenting a shopping interface for items offered for sale by the enterprise, as well as optionally, some items offered for sale through the enterprise by third party partner vendors. In the particular example, each of the two items correspond to items for sale by a particular third party partner vendor, and are allocated to separate partner nodes after evaluation by a DMO application 218. The DMO application 218 determines a list of carrier options/shipping nodes for presentation to the third party partner vendor for selection. In the particular example, the third party partner vendor chooses enterprise-selected carriers 210 for delivery of each of the two items from their respective partner node to the customer user. Because the items of the particular example will originate from two separate nodes in separate packages, two shipping labels will be generated. Each shipping label will be encoded as if the items originate from an enterprise node, and are shipped from the enterprise rather than from the third party partner vendor. Each shipping label is also linked to the customer user’s 202 particular order, as tracked and managed by the enterprise. Therefore, realtime shipping status and tracking data associated with each of the two shipping labels/packages will be received directly at the enterprise systems 204, and the received realtime data for each (i.e. both) will be associated with the customer user’s 202 virtual order. The enterprise systems 204 may provide the customer user 202 (for example, at a user interface on a device 216) with order updates that includes updates relating to both items, even though they were shipped separately from two different partner nodes and via two different carrier vehicles. Additionally, the enterprise systems 204 may provide the customer user 202 with order updates for these ordered items with the same update availability “freshness” as updates regarding other ordered items that are ordered directly from the enterprise, since the enterprise will directly receive electronic shipping update data (e.g., electronic data interchange (EDI) data) from the respective carrier(s) handling shipping of those items.

FIG. 2B illustrates an example enterprise fulfillment operations system 205, which may operate as part of an enterprise system 200. In some examples, enterprise fulfillment systems and operations 205 are configured to receive requests for quote generation from an order coordination platform/application such as order coordination application 203. Such requests may be received at a conductor 232 of the enterprise fulfillment systems and operations systems 205, and may then be transmitted to the DMO application 218. In other examples, such requests may be received directly at the DMO application 218.

The data store 228 may include various information as described above, including (but not limited to) carrier rates 202, carrier services 240, carrier zones 244, carrier time (for examples, as presented in transit tables) 246, carrier calendars 248, and origin/destination (O/D) pair alignments and data 250. The data store 228 may be populated with information provided directly by the carrier systems and/or third party systems. In some embodiments, carrier information is gathered or generated by the enterprise and populated into the data store 228.

Carrier rates 240 provide prices for transporting packages from an origin to the destination. The prices can vary based on distance and speed of shipping as well as other factors (for example, service level and other considerations). In some examples, carrier rates may be related to an enterprise-carrier contracted rate. The speed of shipping may be defined by the service type/level. The distance may be determined based on zip codes, addresses, and/or carrier zones. Carrier rates may be defined by individual packages based on weight. In some examples, carrier rates may be provided for bulk shipments based on number of packages or overall weight of a shipment.

Carrier services 242 refer to different types and speeds of shipping, and may also be referred to as carrier or shipping “service levels.” Domestic carriers may offer different types of service even for a particular transportation mode, for example, by truck or air. The speed of service depends on the distance and type of vehicle used. For example, a shipment could be made as soon as the same day for a higher price. The shipment could travel by plane and truck to arrive at its destination within a defined geographic area. The speed of service could provide for delivery within minutes, hours, or days of an order being placed. In some embodiments, a customer can select from possible delivery speeds. Some local shipments can be made within an hour, two hours, four hours, eight hours, twelve hours, or 24 hours. Local shipments may be completed by contract services or crowd-sourced delivery. In some examples, for a shipment to travel to another state within the same day or even the next day, air travel may be required to transport packages. Such deliveries may be made within 12 hours, 24 hours, 48 hours, or longer. Some services are less costly, but take longer. For example, some ground transport options deliver packages via truck or van and can take up to 10 business days. Other ground transport options may provide for delivery within 7 business days, within 5 business days, within 3 business days, or within 2 business days. Various other options are available that can be weighed for speed versus cost. In some examples, carrier services/service levels 242 available may be based in part on the type of item(s) of the order. For example, if the item requires a refrigerated, frozen, or air-conditioned compartment; is over a certain height or size; is perishable; contains substances or devices that could be potentially hazardous; such conditions may limit which carrier services 242 are feasible for a particular item/order.

Carrier zones 244 may be used to aid in determining the cost of shipping an item or items from one geographic area to another. Carrier zones may be defined by the origin location and/or the destination location. The origin or destination location may be defined by its zip code, address, coordinates, city/municipality, or other geographical designation of location. The distance between origin and destination may define the zones.

Carrier time (for example, in transit tables) 246 may define the time it is expected to take to deliver a shipment from an origin to a destination. In some instances, this is based on the time of travel from one zone (for example, from one zip code or one address) to another. The time in transit tables may differ based on the carrier service 204 utilized.

Carrier calendars 248 may define the days of operation of a given carrier. This can include holidays or other days in which the carrier is not operating, and, in some example, hours of operation. The carrier calendars 248 can differ based on the level of service. For example, critical express services might operate on national holidays, but discount ground services might not. The carrier calendars 248 define the days of operation throughout the year for each carrier and service type. The carrier calendars 248 may differ based on the carrier preference, and/or based on a country or state/province that the carrier is operating within. The carrier calendars 248 mat also provide pick-up times and cut-off schedules. Pick-up times may defined times that a particular carrier is scheduled to pick-up packages at a particular node. Cut-off schedules may be defined times that determine the latest a package can be assigned to a particular carrier in order to be included in the next pick-up.

Origin/destination (O/D) pair alignments 250 may refer to predetermined routes that extend between an origin location and a destination location.

The DMO application 218 may include a cost calculator 254, a time calculator 256, a carrier evaluation module 258, an API 260, and/or other applications.

When a quote request is received at the DMO application 218, information (e.g. data) associated with the quote request is also received. This data may include information about the item and/or the request itself. Among this received data is the type of item order, for example, whether the item is to be fulfilled from an enterprise node 208 or a third party partner vendor node 206. In some examples, the received data includes an order allocation; the order allocation may be to a specific node location or a category/type of node (e.g. enterprise node or third party node). The DMO application 218 determines with which type of order the quote request is associated. In some examples, different carrier rates 240, carrier services 242, carrier zones 244, carrier times 246, carrier calendars 248, and/or O/D pairs are applicable depending on whether the nodes of interest are enterprise nodes or third party nodes. Because these data types (as well as others, in some examples) are utilized as inputs for the DMO application 218 and its applications (for example, cost calculator 254, time calculator 256, and/or carrier evaluation module 258), the determination of order type (e.g. whether the item of the order is fulfilled from an enterprise node or third party node) is important so that the proper input data is selected. Appropriate selection of the input data not only ensures accuracy and relevancy of the final output of the DMO application 218, but also improves efficiency of the DMO application’s 218 computing system, as it only needs to perform calculations/determinations for either enterprise nodes or third party nodes, but not both, for a particular item.

The cost calculator 254 may utilize the carrier rates 240, carrier services 242, and carrier zones 244 to calculate an overall shipping cost for an order or item of an order. In some examples, the cost calculator 254 also may utilize information regarding package weight, dimensions, characteristics, category, and/or contents to determine the cost of shipping. In some examples, the cost may be calculated for a plurality of possible nodes that could supply the items in the order. In some instances, the cost is only calculated for nodes that are within a predefined distance threshold of the destination zip code, address, or zone. The cost calculator 254 may calculate all possible shipping costs between nodes and the customer address. When the order is to be fulfilled from an enterprise node, the cost calculator 254 performs its cost analysis utilizing cost data relating to enterprise nodes and their locations. When the order is to be fulfilled from a third party node, the cost calculator 254 performs its cost analysis utilizing cost data relating to third party nodes and their locations.

The time calculator 256 may utilizes the carrier services 242, carrier time in transit tables 246, and/or carrier calendars 248 to calculate an overall amount of time that a shipment is expected to take to get from a node to a destination. In some example, the time calculator 256 calculates times for multiple nodes that could supply items to a customer in fulfillment of an order. For example, the time calculator 256 may calculate times for nodes having the item(s) of the order in stock. In some examples, times are calculated for one or more nodes that are within a predefined distance threshold of the destination zip code, address, or zone. When the order is to be fulfilled from an enterprise node, the time calculator 256 performs its cost analysis utilizing cost data relating to enterprise nodes and their locations. When the order is to be fulfilled from a third party node, the time calculator 256 performs its cost analysis utilizing cost data relating to third party nodes and their locations.

The carrier evaluation module 258 evaluates possible carrier options that could transport items from nodes to the destination. The carrier evaluation module 258 takes into account the values calculated by the cost calculator 254 and time calculator 256 (as well as other input data, in some examples), to determine which carriers, service levels, and nodes provide the best combination of low cost and timeliness to complete the order (in some examples, within a designated time frame). In some examples, the evaluation is constrained to a particular pre-allocated fulfillment node (in some examples, the item may have already been picked and packed); in other examples, the evaluation may consider one or more nodes and select/assign/allocate the order to a particular node or node options. In some examples, order allocation may occur at an order allocation application. In some examples, such an order allocation application may be a part of (or may operate within) enterprise fulfillment ops 205, order coordination platform 203, or the DMO application 218. The carrier evaluation module 258 determines the optimal shipping mode for one or more nodes. When the order is to be fulfilled from an enterprise node, the carrier evaluation module 258 performs its cost analysis utilizing cost data relating to enterprise nodes and their locations. When the order is to be fulfilled from a third party node, the carrier evaluation module 258 performs its cost analysis utilizing cost data relating to third party nodes and their locations.

In some examples, carrier evaluation model 258 (and therefore the DMO application 218) outputs one or more selected carriers and associated assigned nodes. The output may also include information associated with the selected carriers, for example, cost estimates, shipping details, anticipated delivery times/durations, cost quotes, and/or other information. In a particular example, when the order is to be fulfilled from an enterprise node, the output may include one selected carrier option (and its associated information). In a particular example, when the order is to be fulfilled from third party partner vendor node, the output may include a plurality (e.g. a list) of potential carrier options (and their associated information). In some examples, outputs of the DMO application 218 are stored in a database (for example, data store 228), where they may be accessed by other enterprise applications (for example, conductor(s) 232, SLAM application 234, order coordination platform 203, and/or others). In some examples, outputs of the DMO application 218 are provided, by the DMO application 218 (in some examples, via API 260 and/or conductor(s) 232), to other enterprise applications (for example, conductor(s) 232, SLAM application 234, order coordination platform 203, and/or others).

In some examples, API 260 may facilitate the communication of information (for example, input data and/or output data) between the DMO application 218 and other platforms and applications. For example, the API 260 may communicate information between the DMO application 218 and conductor(s) 232, data store 228, SLAM application 234, other enterprise computing systems (for example, order coordination planform 203), external computing systems (for example, partner vendor systems 210 and/or customer user interfaces 214), and/or others. In some examples, API 260 may be a portion of conductor(s) 232.

In some examples, the output (for example, selected carriers, assigned node, and/or other related information) of a selected shipping option (for example, when a single carrier option is selected by the DMO application when the item is to be fulfilled from an enterprise node, or when a single carrier has been selected by a third party vendor from a list of carrier options initially provided by the DMO application when the item is to be fulfilled from a third party node) is received at SLAM application 234. SLAM application 234 ingests the received selected carrier option and generates a shipping label according to the selected carrier option. Each shipping label may be linked to the order, as tracked and managed by the enterprise. In some examples, when the SLAM application 234 determines that the order is to be fulfilled from a third party node, the shipping label may be encoded as if the items originated from an enterprise node, and as if they are shipped from the enterprise node rather than from the third party partner vendor node. In some examples, when the SLAM application 234 determines the order is to be fulfilled from a third party node, the shipping label may be created such that some internal routing identifiers are omitted from the shipping label (which is to be sent to a third party system and/or third party node); these routing identifiers may include data that is secure data of the enterprise, and are included on shipping labels generated by the SLAM application 234 for order packages being fulfilled/sourced from enterprise nodes. Generating a shipping label that does not include these internal routing identifiers for items that ship from third party nodes increases the security of the enterprise systems and protects sensitive enterprise data.

Once the shipping label has been created, it may be stored in a database (for example, data store 228), where it may be accessed by other enterprise applications (for example, conductor(s) 232, order coordination platform 203, and/or others). In some examples, the generated shipping label may be provided, by the SLAM application 234 (in some examples, via conductor(s) 232), to other enterprise applications (for example, order coordination platform 203, and/or other enterprise fulfillment applications).

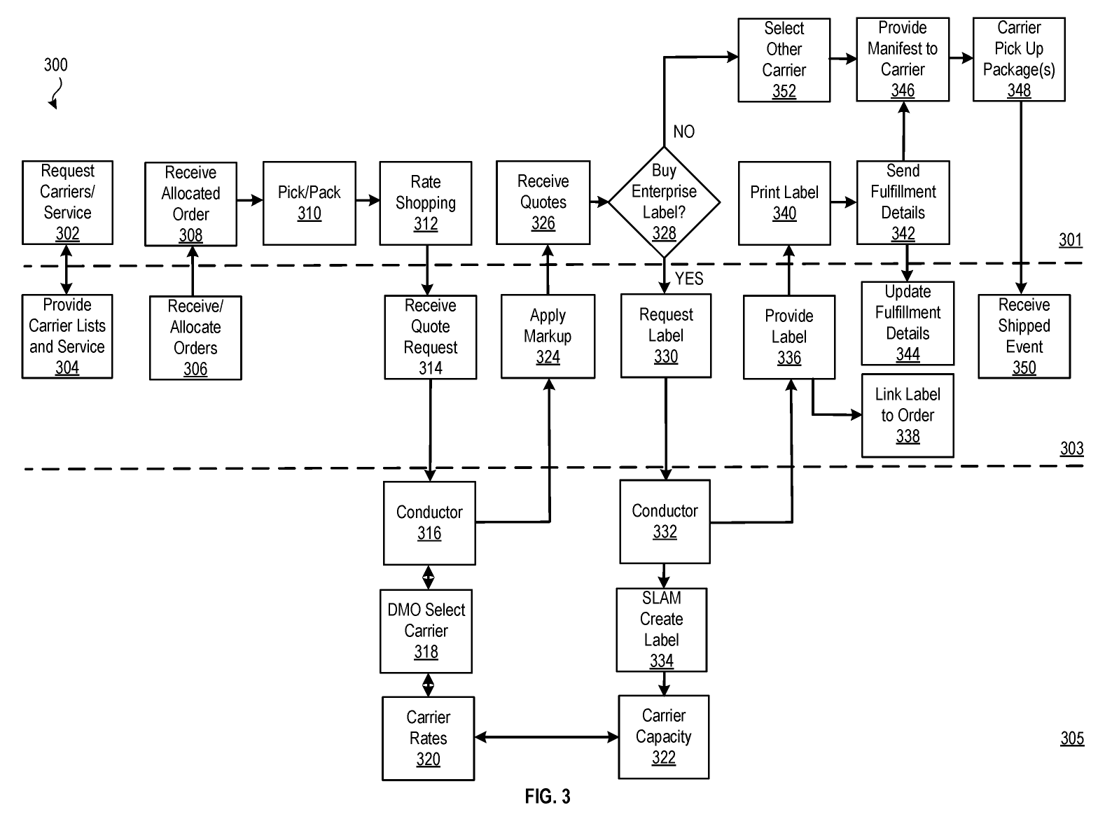

FIG. 3 illustrates an example schematic 300 for receiving item orders, selecting carriers, and generating shipping labels for items, including items fulfilled from third party partner nodes, within which examples of DMO application 218 and SLAM application 23 may operate. In an example, at an operation 302, an enterprise virtual order coordination application 303 (for example, virtual order coordination application 203) receives a request from a third party partner system 301 (for example, third party partner vendor systems 201), for carriers with which the enterprise has contracts, associated service levels and costs, and other carrier information. At an operation 304. the enterprise virtual order coordination application 303 may provide the requested data to the third party partner system 301.

At an operation 306, the enterprise virtual order coordination application 303 receives a virtual order including at least one item allocated to a third party partner vendor node. At an operation 308, the enterprise virtual order coordination application 303 transmits data associated with the items of the virtual order to the third party partner system 301, which receives the transmitted data at operation 308. In some examples, at operation 306, the item(s) is allocated to a specific node location. In some examples, at operation 306, the item(s) is allocated to a node category/type (e.g. a third party node or an enterprise node). In examples, where the item(s) is allocated to a specific node location, upon receipt of the allocated order (at an operation 310), the third party partner system 301 may pick and pack the item(s). At rate shopping 312, in some examples, the third party partner system 301 may evaluate rates associated with carriers with whom the enterprise does not have a contract. At rate shopping 312, in some examples, the third party partner system 301 may send a request to the enterprise virtual order coordination application 303 for a quote and carrier selection from among carriers with whom the enterprise has a contract.

At an operation 314, upon receipt of the request for quote/carrier, the enterprise virtual order coordination application 303 sends a request for quote to an application of enterprise fulfillment systems 305 (for example, enterprise fulfillment operations 305). At an operation 316, a conductor of the enterprise fulfillment systems 305 may receive the request for quotes, and provide it to a DMO application (for example, DMO application 218). At an operation 318, the DMO application selects one or more carriers associated quote(s), in some examples, by performing operations 320 and 322 to evaluate real-time carrier capacity and carrier rates (for example, by accessing data stored in enterprise database 228). In an example, the DMO application provides a single selected carrier and associate quote (for example, when an order indicates that the items are to be fulfilled from an enterprise node). In some examples, the DMO application provides a plurality of potential selected carrier options and quotes associated with each (for example, when an order indicates that the items are to be fulfilled from a third party node).

The selected carrier(s) and associated quote(s) are routed (in some examples, via a conductor operation 316, such as by conductor 232) to the enterprise virtual order coordination application 303. Upon receipt of the selected carrier(s) and associated quote(s) at a markup engine (for example, at a markup engine), at an operation 324, the markup engine applies a markup to each of the received quotes. In an example, the markup may include an amount or percentage of cost added to the quote, to account for the cost of enterprise operations over the generated quote (which is based at least in part on contracted rates and real-time data). The quote(s) (marked-up, if applicable) and selected carrier(s) are transmitted to the third party partner system 301.

At an operation 326, the third party partner system 301 receives the quote(s) and selected carrier(s), and at operation 328, the third party partner system 301 determines whether to select one of the enterprise-provided quote(s) and selected carrier(s) or whether to select another, independent carrier.

If the third party partner system 301 selects one of the enterprise-provided quote(s) and selected carrier(s), the third party partner system 301 notifies the enterprise of its selection and requests an associated shipping label at an operation 330. At operation 330, the enterprise virtual order coordination application 303 receives the request for the shipping label associated with the selected quote/carrier, and transmits a request for generation of a shipping label to an application of enterprise fulfillment systems 305. The request for a shipping label is provided to a SLAM application (for example, SLAM application 234; for example, via a conductor operation 332 by a conductor 232). At an operation 334, the SLAM application generates a shipping label associated with the selected carrier/quote, in some examples, by in accordance with operations 320 and 322. The SLAM application (when the order items are to be fulfilled from the third party node) encodes the item as though it is originating from an enterprise node; the shipping label is encoded such that, when the shipping label is scanned or otherwise read in the future by systems associated with partner nodes, enterprise nodes, carriers, or destinations, the status and tracking data is transmitted directly to the enterprise systems (for example, enterprise virtual order coordination application 303), even when the source node is a partner node. A conductor operation 332 further routes the generated, encoded shipping label to the enterprise virtual order coordination application 303.

Upon receipt of the generated (encoded) shipping label, at operation 338, the enterprise virtual order coordination application 303 links the shipping label to the associated virtual order for the item(s) to be shipped in the package that will have the physical shipping label affixed thereto. Upon receipt of the generated, encoded shipping label, the enterprise virtual order coordination application 303, at operation 336, transmits the generated, encoded shipping label to the third party partner system 301, where it may be transmitted to systems of the specific partner node to which the item(s) were allocated. The shipping label may be transmitted to a printer at the partner node, for printing (at operation 340) of the physical label to be affixed to the package for the shipped item.

Once the item(s)/package has been prepared for shipment (e.g. has been packaged with the encoded, printed label affixed), at operation 342, the third party partner system 301 transmits fulfillment data (e.g. indicating that the package is ready for shipment) to the selected carrier and to the enterprise virtual order coordination application 303. Upon receipt of the transmitted fulfillment data, at an operation 344, the enterprise virtual order coordination application 303 updates fulfillment details and status of the virtual order. The partner system 301, at operation 346, further provides a shipment manifest to the selected carrier 346. The carrier then picks up the package containing the item and with the shipping label affixed, for shipment to the destination. Once the carrier picks up the package, at operation 348, the partner system 301 transmits data to the enterprise virtual order coordination application 303 that the item package has been shipped. Upon receipt of the shipment notification event at operation 350, the enterprise virtual order coordination application 303 further updates virtual order status and fulfillment data at an operation 344.

If another carrier is selected at an operation 352, the third party partner system 301 provides a shipment manifest to the selected carrier 346. The carrier then picks up the package (which does not have an enterprise-generated, encoded shipment label affixed) for shipment to the destination. Once the carrier picks up the package, at operation 348, the partner system 301 transmits data to the enterprise virtual order coordination application 303 that the item package has been shipped. Upon receipt of the shipment notification event at operation 350, the enterprise virtual order coordination application 303 further updates virtual order status and fulfillment data at an operation 344.

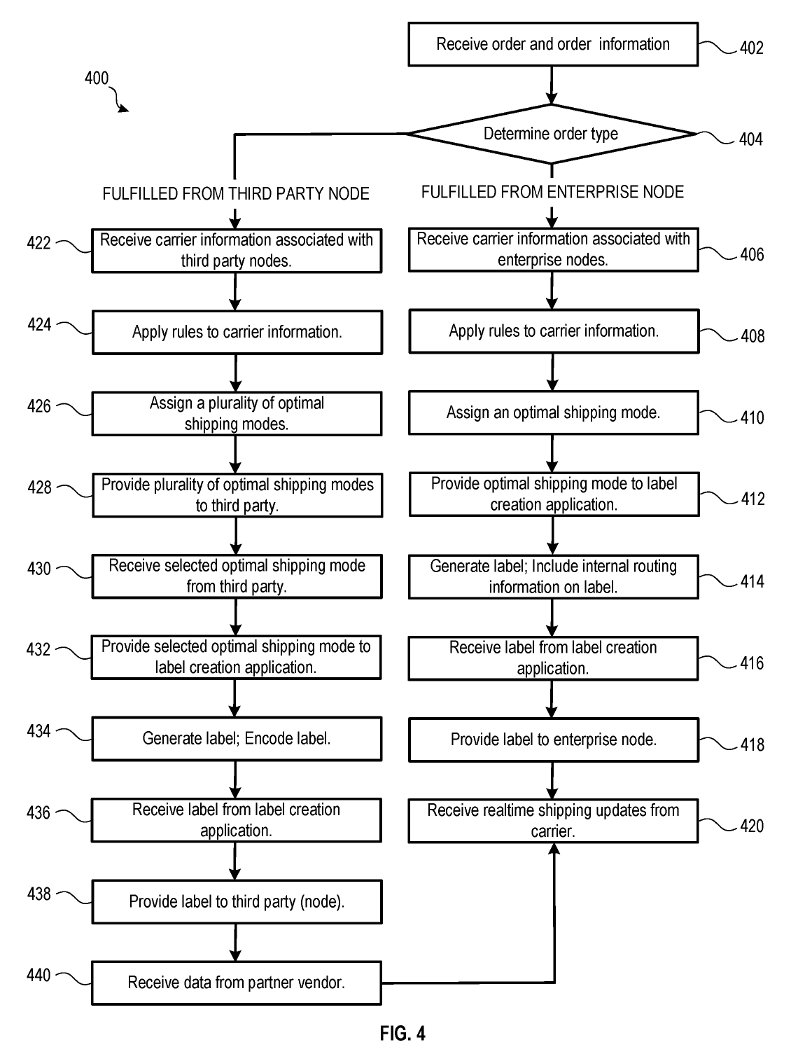

FIG. 4 illustrates an example process 400 for receiving item orders, selecting carriers, and generating shipping labels for items including items fulfilled from third party partner nodes. At operation 402, an order (or, in some examples, a portion of an order) comprising one or more items to be fulfilled from a node is received, along with related information/data. The order and order information may be received, for example, at a DMO application (for example, DMO application 218).

At operation 404, the order type is determined, for example, whether the item(s) of the order is to be fulfilled from an enterprise node or a third party node.

If the item(s) is to be fulfilled from an enterprise node, at operation 406, carrier information is received (for example, from a database such as data store 228) relating to enterprise nodes.

At operation 408, a set of rules are applied to the enterprise carrier information, for example, taking into account carrier rates, carrier zones, carrier services, carrier time (for example, in transit tables), carrier calendars, O/D pair alignments, and/or other information.

Based on the outcome of the rules application, at operation 410, at least one optimal shipping mode (for example, including a selected carrier and assigned node) is assigned to the item(s) of the order. The selected optimal shipping mode may be selected to balance at least cost and timing factors.

At an operation 412, the optimal shipping mode is provided to a label creation application (for example, a SLAM application 234).

At operation 414, a shipping label is created according to the optimal shipping mode. The shipping label may include internal (to the enterprise) routing information.

At operation 416, the created shipping label is received at the enterprise fulfillment systems, and at operation 418, the created shipping label is provided to the enterprise node. The enterprise node may receive the shipping label, for example, at a printer. A physical label may be printed based on the created shipping label, and the physical label may be affixed to the package of the item(s) prior to shipping via the selected carrier associated with the optimal shipping mode. During the shipping process, the physical label may be scanned to allow real-time shipping updates and status of the package to be gathered by the origin node, the destination, and/or the carrier.

At operation 420, real-time shipping updates may be received at the enterprise computing systems directly from the carrier computing systems.

If the item(s) is to be fulfilled from a third party node, at operation 422, carrier information is received (for example, from a database such as data store 228) relating to third party nodes.

At operation 424, a set of rules are applied to the third party carrier information, for example, taking into account carrier rates, carrier zones, carrier services, carrier time (for example, in transit tables), carrier calendars, O/D pair alignments, and/or other information.

Based on the outcome of the rules application, at operation 426, a plurality of optimal shipping modes (for example, including a selected carrier and assigned node for each optimal shipping mode) are generated for the item(s) of the order. The plurality of optimal shipping modes may be selected to balance at least cost and timing factors.

At operation 428, the plurality of optimal shipping modes are provided to the third party. In some examples, a user interface (for example, partner vendor user interface 222 or 622) may be generated that presents the plurality of optimal shipping modes to the third party, and that provides the third party interactive features by which to select one of the presented optimal shipping modes (or, in some examples, to select an alternative shipping mode not covered under an enterprise contracted rate).

At operation 430, a selected optimal shipping mode (e.g. of the plurality of optimal shipping modes) is received from the third party.

At an operation 432, the selected optimal shipping mode is provided to a label creation application (for example, a SLAM application 234).

At operation 434, a shipping label is created according to the optimal shipping mode. Based on the determination that the item(s) are to be fulfilled from a third party node: (1) the shipping label is generated so as to not include enterprise-internal routing information (to secure enterprise-sensitive data); and/or (2) the shipping label is encoded such that real-time shipping updates may be received by the enterprise (instead of only being received by the third party).

At operation 436, the created shipping label is received at the enterprise systems (for example, an order coordination platform 203), and at operation 438, the created shipping label is provided to the third party computing systems (and ultimately the third party node). The third party node may receive the shipping label, for example, at a printer. A physical label may be printed based on the created shipping label, and the physical label may be affixed to the package of the item(s) prior to shipping via the selected carrier associated with the selected optimal shipping mode. During the shipping process, the physical label may be scanned to allow real-time shipping updates and status of the package to be gathered by the origin node, the destination, and/or the carrier.

At operation 420, real-time shipping updates may be received at the enterprise computing systems directly from the carrier computing systems.

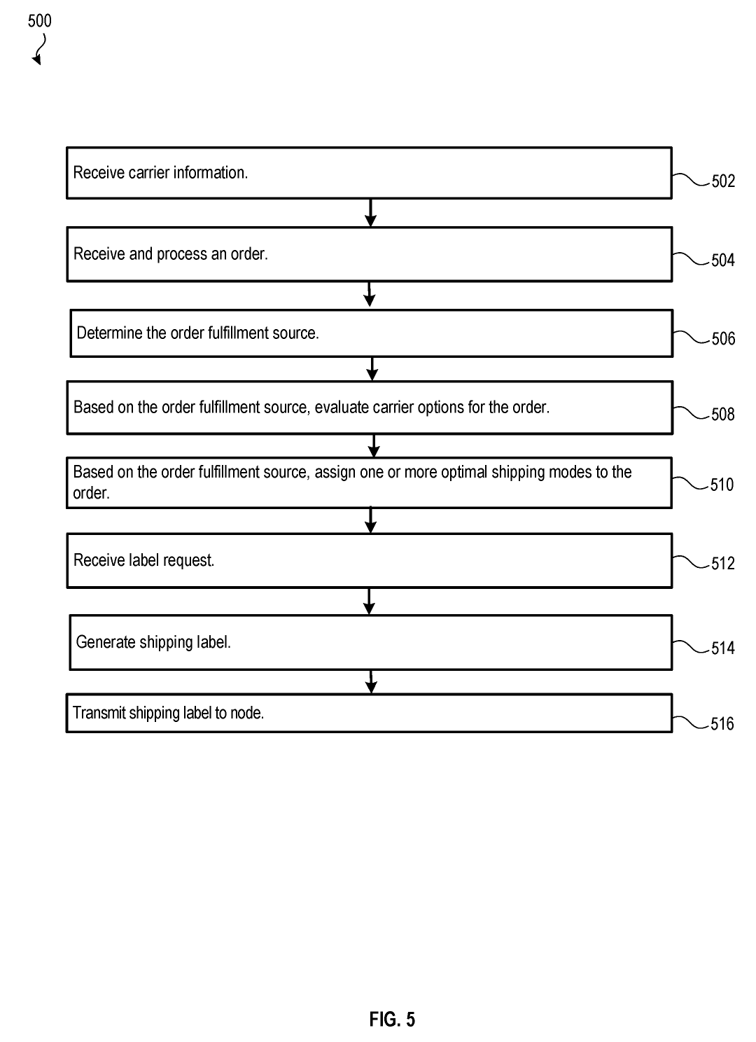

FIG. 5 illustrates example operations 500 for selecting one or more optimal shipping modes for one or more items of an order. The operations 500 may be performed by systems described herein in FIGS. 1-3, for example, by one or more systems of the enterprise, such as an enterprise virtual order coordination application and/or enterprise fulfillment operations. At operation 502, carrier information is received. In some examples, the carrier information may also be stored (for example, in a database/data store 228). The carrier information may include carrier rates, carrier services, carrier zones, whether the carrier has a contracted rate with the enterprise, carrier time, and/or other carrier information as related to each of a plurality of enterprise nodes and as related to each of a plurality of third party nodes.

At operation 504, an order is received and processed. At a delivery mode optimizer (DMO) application, a quote request associated with the order may be received (for example, from the order coordination application).

At operation 506, the fulfillment source for the order (e.g. item(s) of the order) is determined at the DMO application. For example, the DMO application may determine, from the received order and its associated information, whether the order is to be fulfilled from an enterprise node or a third party node.

At operation 508, based on the order fulfillment source, carrier options are evaluated for the order. The evaluation type may be based on whether the order is to be fulfilled from an enterprise node or a third party node. When the order is to be fulfilled from an enterprise node of the plurality of enterprise nodes, evaluating carrier options for the order includes receiving carrier information associated with the plurality of enterprise nodes from the carrier data store; and applying one or more rules to the carrier information associated with the plurality of enterprise nodes. The one or more rules may include at least time and cost balancing considerations. The one or more rules may take into account data such as that found in carrier rates 240, carrier zones 244, carrier calendars 248, carrier services 242, carrier time 246, O/D pair alignments 250, and/or other data associated with the enterprise node(s).

When the order is to be fulfilled from a third party node of the plurality of third party nodes, evaluating carrier options for the order includes receiving carrier information associated with the plurality of third party nodes from the carrier data store; and applying one or more rules to the carrier information associated with the plurality of third party nodes. The one or more rules may include at least time and cost balancing considerations. The one or more rules may take into account data such as that found in carrier rates 240, carrier zones 244, carrier calendars 248, carrier services 242, carrier time 246, O/D pair alignments 250, and/or other data associated with the third party node(s).

At operation 510, based on the order fulfillment source, one or more optimal shipping modes are assigned to the order. The one or more optimal shipping modes may be assigned based on the evaluated carrier options, and each optimal shipping modes may specify a carrier and, in some examples, an assigned node. When the order is to be fulfilled from an enterprise node, at least one optimal shipping mode is assigned to the order (in some examples, one best optimal shipping mode is assigned), and the assigned node is one of the plurality of enterprise nodes. When the order is to be fulfilled from a third party node, a plurality of optimal shipping modes are assigned to the order, and the assigned node is one of the plurality of third party nodes.

In some examples, when the order is to be fulfilled from a third party node, a user interface is generated that includes the plurality of optimal shipping modes. The user interface is provided to the partner vendor. A responsive communication may then be received from the partner vendor including a signal of a partner vendor interaction with the user interface, the signal indicating a shipping mode selection. The partner vendor (user) may select one of the plurality of optimal shipping modes, or, in some examples, may select an alternate shipping mode/carrier.

In some examples, the one or more optimal shipping modes of the order are provided to a carrier quota management application (for example, carrier quota management application 262). At the carrier quota management application, carrier quota information is received that is associated with each carrier of the one or more optimal shipping modes. The carrier quota application then reserves an amount of quota capacity for the order for each carrier of the one or more optimal shipping modes. Then, when a selected carrier associated with a selected optimal shipping modes is received (for example, either a single optimal shipping mode for an order fulfilled from an enterprise node, or a third party-selected optimal shipping mode for an order fulfilled from a third party node), the carrier quota management application may release the reserved amount of quota capacity for any unselected carriers of the one or more optimal shipping modes, so that the released capacity is available for other orders to utilize.

At operation 512, a label request is received at a shipping label and manifest (SLAM) application. The label request may include the selected shipping carrier associated with a selected shipping mode (for example, either a single optimal shipping mode for an order fulfilled from an enterprise node, or a third party-selected optimal shipping mode for an order fulfilled from a third party node).

At operation 514, a shipping label associated with the order is generated, based on whether the order is to be fulfilled from an enterprise node or a third party node. When the order is to be fulfilled from an enterprise node, the generated label comprises enterprise-sensitive data. When the order is to be fulfilled from a third party node of the plurality of third party nodes (1) generating the label includes encoding the label with information identifying the order as being associated with the enterprise, and/or (2) the generated label does not comprise enterprise-sensitive data.

When the order is to be fulfilled from an enterprise node, the generated label is received and provided to an appropriate system of the enterprise fulfillment systems. When the order is to be fulfilled from a third party node, the generated label is received and provided to a third party computing system. At operation 516, the generated shipping label is transmitted to the node to which the order is allocated/assigned (e.g. the enterprise node or the third party node).

When the order is fulfilled from an enterprise node, shipment data associated with shipping of the item from the enterprise node to the customer address is received (for example, from the enterprise fulfillment computing system and/or the enterprise node), via the selected shipping carrier. Realtime shipping updates related to the generated label are received directly at the enterprise computing systems from the selected shipping carrier.

When the order is fulfilled from a third party node, shipment data associated with shipping of the item from the third party node to the customer address is received (for example, from the third party computing system and/or the third party node), via the selected shipping carrier. Realtime shipping updates related to the generated label are received directly at the enterprise computing systems from the selected shipping carrier. The order data may be updated based at least on the associated received realtime shipping updates. The real time shipping updates may comprise at least one of a shipment status and/or a shipment tracking location, as well as other shipping update data as described herein.

In some examples, providing the label to the assigned node causes the generated label to be provided to a printer at the node. The node may print, at the printer, a physical label in accordance with the generated label. The physical label may then be affixed to a package containing the item of the order. The physical label may be scanned or otherwise read throughout the shipment process to provide shipping updates (for example, including tracking, location, status, delivery, and/or other data) and/or to serve as a basis for shipment calculations such as estimated delivery dates/times, to the computing systems described herein.

In some examples, when an order is fulfilled from a third party node, the encoded label may be linked to the item and to the order. The received real time shipping updates may be associated/linked to the item and to the order.

In some examples, a shipping status request associated with the order maybe received from a customer user device. A status user interface presentable at the customer user device may be generated. The status user interface may include shipping status information including the realtime shipping updates, regardless of whether the item(s) of the order were fulfilled from an enterprise node or a third party node. In some examples, the order includes a first item fulfilled from a third party node and a second item fulfilled from an enterprise node. In such an example, in response to a shipping status request, the status user interface includes real time shipping updates regarding both the first item and the second item.

In some examples, at an order allocator platform, a selected shipping carrier associated with a selected optimal shipping mode (for example, either a single optimal shipping mode for an order fulfilled from an enterprise node, or a third party-selected optimal shipping mode for an order fulfilled from a third party node) may be received. The order may be allocated to one or more nodes consistent with the selected optimal shipping mode, based at least on item availability at the nodes, success rates of the nodes, shipping schedules for the nodes, and/or other data (for example, data of datastore 228). The DMO application may receive confirmation from the assigned node (for example, an enterprise node or a third party node, as appropriate) of the selected optimal shipping node; the confirmation including a request to reevaluate the carrier options for the selected optimal shipping mode. The carrier options for the selected optimal shipping mode may be reevaluated, based on the time that the order is prepared at the assigned node. Based on the reevaluated carrier options, a final optimal shipping mode is assigned to the order, the final optimal shipping mode specifying a final carrier and the assigned node. This ensures that the final selected carrier takes into account any changes that may have happened during the fulfillment and/or pick and pack processes. This final selected carrier may be, in some examples, included in the final optimal shipping mode that is communicated to the SLAM application (for example, at operation 512), for generation of a label associated with the order (for example, at operation 514), so that the generated label may be provided to the assigned node (for example, at operation 516) for printing and affixing to the package.

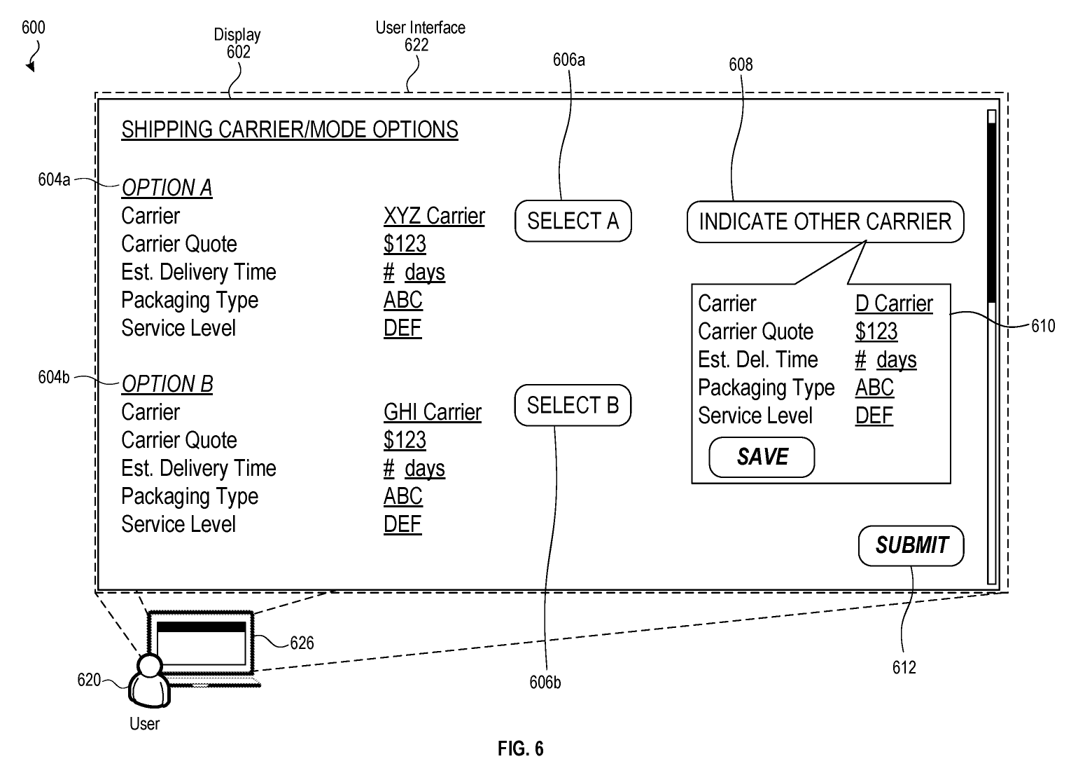

FIG. 6 illustrates an example third party user interface 600 for selection of a shipping carrier/mode from a set of provided optimal shipping options. In the particular example shown, a partner vendor user 620 (for example, third party partner vendor user 220) interacts with a partner user interface 622 (for example, partner user interface 222) on display 602 of a partner user device 626 (for example, partner user device 226). Partner user interface 622 may display one or more enterprise-provided carrier options (in the example shown, two options are presented: Option A 604a and Option B 604b, however, fewer or more than two options may be provided in other examples) for shipment of an item associated with a virtual order allocated to a third party node, along with information associated with each carrier option, to allow the partner user 620 to choose whether or not to choose one of the displayed carrier options 604a or 604b. Such information may include a quote amount (for example, a marked-up quote), delivery time and/or day, packaging type, service level, and/or other information relevant to the pick-up, shipping, delivery, cost, or fulfillment of the item.

User interface 622 may include one or more interactive features 606a or 606b by which a partner vendor user 620 may indicate selection of one of the presented carrier options 604a or 604b. User interface 622 may include one or more interactive features 608 by which the partner vendor user 620 may indicate selection of an alternative carrier. In some examples, an interactive feature 610 may allow the partner vendor user 620 to input information related to the alternative carrier for indication to the enterprise. In some examples, the provided carrier options 604a, 604b and/or the alternate carrier may have one or more costs, delivery times, packaging type, service levels, and/or other features that differ from one another or are alike between each other. Once a carrier is selected, the partner vendor user 620 may select a feature 612 which submits the carrier option selection to the enterprise computing systems (for example, to a virtual order coordination platform 203).

Interactive features 606a, 606b, 608, 610, 612 may include one or more of buttons, toggles, checkboxes, switches, text boxes, or other features the partner vendor user 620 may interact with by mouse, keyboard, touchscreen, touchpad, joystick, voice command, stylus, or other device interaction components. Interaction with one of features 606a, 606b, 608, 610, 612 may cause the partner computing systems disclosed herein to take action and/or transmit data as described herein, based on the nature of the feature interaction.

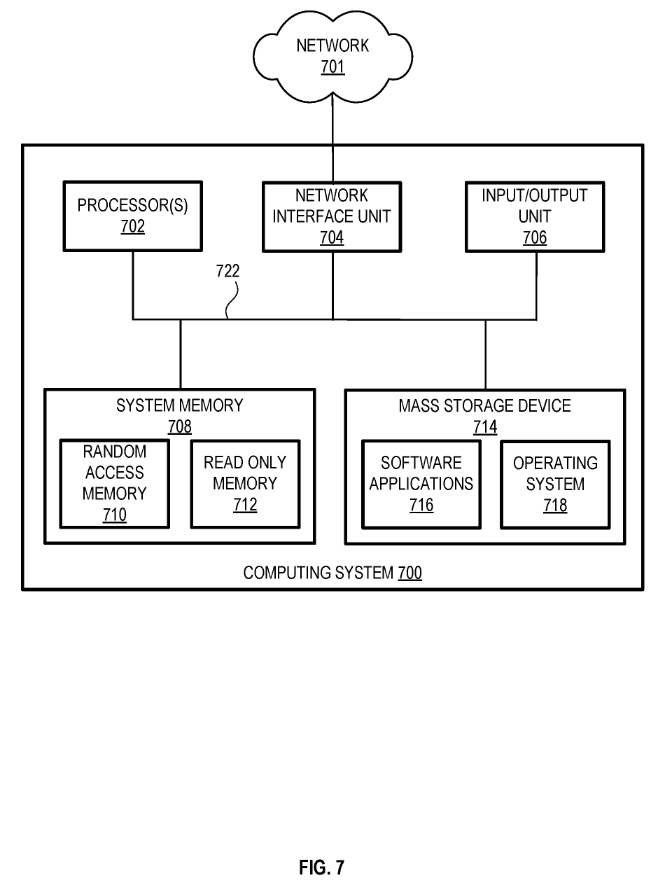

FIG. 7 illustrates an example block diagram of a virtual or physical computing system 700. One or more aspects of the computing system 700 can be used to implement the systems described herein, store instructions described herein, and preform operations described herein.

In the embodiment shown, the computing system 700 includes one or more processors 702, a system memory 708, and a system bus 722 that couples the system memory 708 to the one or more processors 702. The system memory 708 includes RAM (Random Access Memory) 710 and ROM (Read-Only Memory) 712. A basic input/output system that contains the basic routines that help to transfer information between elements within the computing system 700, such as during startup, is stored in the ROM 712. The computing system 700 further includes a mass storage device 714. The mass storage device 714 is able to store software instructions and data. The one or more processors 702 can be one or more central processing units or other processors.

The mass storage device 714 is connected to the one or more processors 702 through a mass storage controller (not shown) connected to the system bus 722. The mass storage device 714 and its associated computer-readable data storage media provide non-volatile, non-transitory storage for the computing system 700. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 700.

According to various embodiments of the invention, the computing system 700 may operate in a networked environment using logical connections to remote network devices through the network 701. The network 701 is a computer network, such as an enterprise intranet and/or the Internet. The network 701 can include a LAN, a Wide Area Network (WAN), the Internet, wireless transmission mediums, wired transmission mediums, other networks, and combinations thereof. The computing system 700 may connect to the network 701 through a network interface unit 704 connected to the system bus 722. It should be appreciated that the network interface unit 704 may also be utilized to connect to other types of networks and remote computing systems. The computing system 700 also includes an input/output controller 706 for receiving and processing input from a number of other devices, including a touch user interface display screen, or another type of input device. Similarly, the input/output controller 706 may provide output to a touch user interface display screen or other type of output device.

As mentioned briefly above, the mass storage device 714 and the RAM 710 of the computing system 700 can store software instructions and data. The software instructions include an operating system 718 suitable for controlling the operation of the computing system 700. The mass storage device 714 and/or the RAM 710 also store software instructions, that when executed by the one or more processors 702, cause one or more of the systems, devices, or components described herein to provide functionality described herein. For example, the mass storage device 714 and/or the RAM 710 can store software instructions that, when executed by the one or more processors 702, cause the computing system 700 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures, systems, and methods shown and described above.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computing system, comprising:
at least one processor; and
at least one memory storing computer-executable instructions, the computer-executable instructions when executed by the at least one processor causing the computing system to:
receive and storing carrier information in a carrier data store, the carrier information comprising carrier rates, carrier services, carrier zones, and carrier time, for each of a plurality of enterprise nodes and for each of a plurality of third party nodes;
receive, at a customer user interface associated with an enterprise, an order from a customer for one or more items to be delivered to a customer address, wherein the order may be fulfilled from an enterprise node of the plurality enterprise nodes or a third party node of the plurality of third party nodes;
process, at an order coordination application, the order;
receive, at a delivery mode optimizer application, from the order coordination application, a quote request associated with the order;
determine, at the delivery mode optimizer application, whether the order is to be fulfilled from an enterprise node or a third party node;
based on whether the order is to be fulfilled from an enterprise node of the plurality of enterprise nodes or a third party node of the plurality of third party nodes, evaluate, at the delivery mode optimizer application, carrier options for the order at the delivery mode optimizer, wherein:
when the order is to be fulfilled from an enterprise node of the plurality of enterprise nodes, evaluating carrier options for the order comprises:
receiving carrier information associated with the plurality of enterprise nodes from the carrier data store; and
applying one or more rules to the carrier information associated with the plurality of enterprise nodes, wherein the one or more rules include at least time and cost considerations, and
when the order is to be fulfilled from a third party node of the plurality of third party nodes, evaluating carrier options for the order comprises:
receiving carrier information associated with the plurality of third party nodes from the carrier data store; and
applying one or more rules to the carrier information associated with the plurality of third party nodes, wherein the one or more rules include at least time and cost considerations; and
assign, at the delivery mode optimizer application, based on the evaluated carrier options, one or more optimal shipping modes to the order, the optimal shipping modes specifying a carrier and an assigned node, wherein:
when the order is to be fulfilled from an enterprise node, at least one optimal shipping mode is assigned to the order, and the assigned node is one of the plurality of enterprise nodes, and
when the order is to be fulfilled from a third party node, a plurality of optimal shipping modes are assigned to the order, and the assigned node is one of the plurality of third party nodes.

2. The computing system of claim 1, further comprising instructions to:
receive, at an order allocator platform, a selected shipping carrier associated with a selected optimal shipping mode of the one or more optimal shipping modes;
allocate, at the order allocator platform, the order to one or more nodes consistent with the selected optimal shipping mode, based at least on item availability at the nodes, success rates of the nodes, and shipping schedules for the nodes;
receive, at the delivery mode optimizer application, a confirmation from the assigned node of the selected optimal shipping node, a confirmation including a request to reevaluate the carrier options for the selected optimal shipping mode;
reevaluate the carrier options for the selected optimal shipping mode, based on the time that the order is prepared at the assigned node;
based on the reevaluated carrier options, assign a final optimal shipping mode to the order, the final optimal shipping mode specifying a final carrier and the assigned node;
communicate the final optimal shipping mode to a shipping label and manifest application;
generate, at the shipping label and manifest application, a label associated with the order; and
provide the label to the assigned node.

3. The computing system of claim 1, further comprising instructions to:
receive, at a shipping label and manifest application, a selected shipping carrier associated with a selected shipping mode; and
based on whether the order is to be fulfilled from an enterprise node of the plurality of enterprise nodes or a third party node of the plurality of third party nodes, generate, at the shipping label and manifest application, a label associated with the order, wherein:
when the order is to be fulfilled from an enterprise node of the plurality of enterprise nodes, the generated label comprises enterprise-sensitive data, and
when the order is to be fulfilled from a third party node of the plurality of third party nodes, generating the label comprises encoding, at the label creation application, the label with information identifying the order as being associated with the enterprise, wherein the generated label does not comprise enterprise-sensitive data.

4. The computing system of claim 3, further comprising instructions to:
receive the generated label;
provide the generated label to an enterprise fulfillment computing system;
receive, from the enterprise fulfillment computing system, shipment data associated with shipping of the item from the enterprise node to the customer address via the selected shipping carrier; and
receive, directly from the selected shipping carrier, realtime shipping updates related to the generated label.

5. The computing system of claim 3, further comprising instructions to:
receive the generated label;
provide the generated label to a third party computing system;
receive, from the third party computing system, shipment data associated with shipping of the order from the third party node to a the customer address via the selected shipping carrier; and
receive, directly from the selected shipping carrier, realtime shipping updates related to the generated label.

6. The computing system of claim 5, further comprising instructions to:
receive a shipping status request associated with the order from a customer user device; and
generate a status user interface presentable at the customer user device, the user interface comprising shipping status information including the realtime shipping updates.

7. The computing system of claim 1, further comprising instructions to:
provide the one or more optimal shipping modes of the order to a carrier quota management application;
at the carrier quota management application, receive carrier quota information associated with each carrier of the one or more optimal shipping modes;
reserve an amount of quota capacity for the order for each carrier of the one or more optimal shipping modes;
receive, at the carrier quota management application, a selected carrier associated with one of the one or more optimal shipping modes; and
by the carrier quota management application, release the reserved amount of quota capacity for any unselected carriers of the one or more optimal shipping modes.

8. The computing system of claim 1, further comprising instructions to:
generate a user interface comprising the plurality of optimal shipping modes;
provide the user interface to the partner vendor; and
receive a responsive communication from the partner vendor comprising a signal of a partner vendor interaction with the user interface, the signal comprising a shipping mode selection.

9. A method, comprising:
receiving and storing carrier information in a carrier data store, the carrier information comprising carrier rates, carrier services, carrier zones, and carrier time, for each of a plurality of enterprise nodes and for each of a plurality of third party nodes;
receiving, at a customer user interface associated with an enterprise, an order from a customer for one or more items to be delivered to a customer address, wherein the order may be fulfilled from an enterprise node of the plurality enterprise nodes or a third party node of the plurality of third party nodes;
processing, at an order coordination application, the order;
receiving, at a delivery mode optimizer application, from the order coordination application, a quote request associated with the order;
determining, at the delivery mode optimizer application, whether the order is to be fulfilled from an enterprise node or a third party node;
based on whether the order is to be fulfilled from an enterprise node of the plurality of enterprise nodes or a third party node of the plurality of third party nodes, evaluating, at the delivery mode optimizer application, carrier options for the order at the delivery mode optimizer, wherein:
when the order is to be fulfilled from an enterprise node of the plurality of enterprise nodes, evaluating carrier options for the order comprises:
receiving carrier information associated with the plurality of enterprise nodes from the carrier data store; and
applying one or more rules to the carrier information associated with the plurality of enterprise nodes, wherein the one or more rules include at least time and cost considerations, and
when the order is to be fulfilled from a third party node of the plurality of third party nodes, evaluating carrier options for the order comprises:
receiving carrier information associated with the plurality of third party nodes from the carrier data store; and
applying one or more rules to the carrier information associated with the plurality of third party nodes, wherein the one or more rules include at least time and cost considerations; and
assigning, at the delivery mode optimizer application, based on the evaluated carrier options, one or more optimal shipping modes to the order, the optimal shipping modes specifying a carrier and an assigned node, wherein:
when the order is to be fulfilled from an enterprise node, at least one optimal shipping mode is assigned to the order, and the assigned node is one of the plurality of enterprise nodes, and
when the order is to be fulfilled from a third party node, a plurality of optimal shipping modes are assigned to the order, and the assigned node is one of the plurality of third party nodes.

10. The method of claim 9, further comprising:
receiving, at an order allocator platform, a selected shipping carrier associated with a selected optimal shipping mode of the one or more optimal shipping modes;
allocating, at the order allocator platform, the order to one or more nodes consistent with the selected optimal shipping mode, based at least on item availability at the nodes, success rates of the nodes, and shipping schedules for the nodes;
receiving, at the delivery mode optimizer application, a confirmation from the assigned node of the selected optimal shipping node, a confirmation including a request to reevaluate the carrier options for the selected optimal shipping mode;
reevaluating the carrier options for the selected optimal shipping mode, based on the time that the order is prepared at the assigned node;
based on the reevaluated carrier options, assigning a final optimal shipping mode to the order, the final optimal shipping mode specifying a final carrier and the assigned node;
communicating the final optimal shipping mode to a shipping label and manifest application;
generating, at the shipping label and manifest application, a label associated with the order; and
providing the label to the assigned node.

11. The method of claim 9, further comprising:
receiving, at a shipping label and manifest application, a selected shipping carrier associated with a selected shipping mode; and
based on whether the order is to be fulfilled from an enterprise node of the plurality of enterprise nodes or a third party node of the plurality of third party nodes, generating, at the shipping label and manifest application, a label associated with the order, wherein:
when the order is to be fulfilled from an enterprise node of the plurality of enterprise nodes, the generated label comprises enterprise-sensitive data, and
when the order is to be fulfilled from a third party node of the plurality of third party nodes, generating the label comprises encoding, at the label creation application, the label with information identifying the order as being associated with the enterprise, wherein the generated label does not comprise enterprise-sensitive data.

12. The method of claim 11, further comprising:
receiving the generated label;
providing the generated label to an enterprise fulfillment computing system;
receiving, from the enterprise fulfillment computing system, shipment data associated with shipping of the item from the enterprise node to the customer address via the selected shipping carrier; and
receiving, directly from the selected shipping carrier, realtime shipping updates related to the generated label.

13. The method of claim 11, further comprising:
receiving the generated label;
providing the generated label to a third party computing system;
receiving, from the third party computing system, shipment data associated with shipping of the order from the third party node to the customer address via the selected shipping carrier; and
receiving, directly from the selected shipping carrier, realtime shipping updates related to the generated label.

14. The method of claim 13, further comprising:
receiving a shipping status request associated with the order from a customer user device; and
generating a status user interface presentable at the customer user device, the user interface comprising shipping status information including the realtime shipping updates.

15. The computing system of claim 1, further comprising instructions to:
providing the one or more optimal shipping modes of the order to a carrier quota management application;
at the carrier quota management application, receiving carrier quota information associated with each carrier of the one or more optimal shipping modes;
reserving an amount of quota capacity for the order for each carrier of the one or more optimal shipping modes;
receiving, at the carrier quota management application, a selected carrier associated with one of the one or more optimal shipping modes; and
by the carrier quota management application, releasing the reserved amount of quota capacity for any unselected carriers of the one or more optimal shipping modes.

16. The method of claim 9, further comprising:
generating a user interface comprising the plurality of optimal shipping modes;
providing the user interface to the partner vendor; and
receiving a responsive communication from the partner vendor comprising a signal of a partner vendor interaction with the user interface, the signal comprising a shipping mode selection.

17. A computing system, comprising:
at least one processor; and
at least one memory storing computer-executable instructions, the computer-executable instructions when executed by the at least one processor causing the computing system to:
receive and storing carrier information in a carrier data store, the carrier information comprising carrier rates, carrier services, carrier zones, and carrier time, for each of a plurality of enterprise nodes and for each of a plurality of third party nodes;
receive, at a customer user interface associated with an enterprise, an order from a customer for one or more items to be delivered to a customer address, wherein the order may be fulfilled from an enterprise node of the plurality enterprise nodes or a third party node of the plurality of third party nodes;
process, at an order coordination application, the order;
receive, at a delivery mode optimizer application, from the order coordination application, a quote request associated with the order;
determine, at the delivery mode optimizer application, that the order is to be fulfilled from a third party node;
evaluate, at the delivery mode optimizer application, carrier options for the order at the delivery mode optimizer, wherein evaluating carrier options for the order comprises:
receiving carrier information associated with the plurality of third party nodes from the carrier data store; and
applying one or more rules to the carrier information associated with the plurality of third party nodes, wherein the one or more rules include at least time and cost considerations;
assign, at the delivery mode optimizer application, based on the evaluated carrier options, one or more optimal shipping modes to the order, the optimal shipping modes specifying a carrier and an assigned node, wherein a plurality of optimal shipping modes are assigned to the order, and the assigned node is one of the plurality of third party nodes;
provide the plurality of optimal shipping modes to a third party computing system;
receive a responsive communication from the third party computing system comprising a signal of a selected shipping mode of the plurality of optimal shipping modes;
provide the selected shipping mode to a shipping label and manifest application, including a selected carrier associated with a selected shipping mode; and
generate, at the shipping label and manifest application, a label associated with the order, wherein generating the label comprises encoding, at the label creation application, the label with information identifying the order as being associated with the enterprise, wherein the generated label does not comprise enterprise-sensitive data.

18. The computing system of claim 17, further comprising instructions to:
receive the generated label;
provide the generated label to the third party computing system;
receiving, from the third party computing system, shipment data associated with shipping of the order from the third party node to the customer address via the selected carrier; and
receiving, directly from the selected carrier, realtime shipping updates related to the generated label.

19. The computing system of claim 18, further comprising instructions to:
receive a shipping status request associated with the order from a customer user device; and
generate a status user interface presentable at the customer user device, the user interface comprising shipping status information including the realtime shipping updates.

20. The computing system of claim 17, further comprising instructions to:
provide the plurality of optimal shipping modes of the order to a carrier quota management application;
at the carrier quota management application, receive carrier quota information associated with each carrier of the plurality of optimal shipping modes;
reserve an amount of quota capacity for the order for each carrier of the plurality of optimal shipping modes;
receive, at the carrier quota management application, the selected carrier associated with the selected shipping mode; and
by the carrier quota management application, release the reserved amount of quota capacity for any unselected carriers of the plurality of optimal shipping modes.
